(19) United States
(12) Patent Application Publication
(10) Pub. No.: US 2018/0253671 A1
(43) Pub. Date: Sep. 6, 2018

(54) PRESENTING METHOD, PRESENTING DEVICE, AND NON-TRANSITORY COMPUTER-READABLE RECORDING MEDIUM STORING A PRESENTING PROGRAM

(71) Applicant: Panasonic Intellectual Property Corporation of America, Torrance, CA (US)

(72) Inventor: SHUNSUKE KUHARA, Osaka (JP)

(21) Appl. No.: 15/897,238

(22) Filed: Feb. 15, 2018

(30) Foreign Application Priority Data
Mar. 1, 2017 (JP) 2017-038427

(51) Int. Cl. G06Q 10/06; G06F 3/147

(52) U.S. Cl. CPC G06Q 10/06312; G06F 3/04817; G06F 3/147

(57) ABSTRACT

A terminal device obtains an electronic floor plan of a predetermined space. The terminal device also obtains area information indicating a plurality of seating target areas based on the floor plan. The terminal device obtains position information indicating a current position of the autonomous cleaner in the predetermined space, and obtains person-presence information indicating whether or not a person is present in one of the plurality of seating target areas. The terminal device identifies a surrounding area of the autonomous cleaner based on the current position of the autonomous cleaner, the surrounding area indicating a predetermined range around the autonomous cleaner. Further, the terminal device determines seating target areas not overlapping with the surrounding area as being guest-ready candidate areas, and guest-ready candidate areas where there is no person present as being guest-ready areas. The terminal device displays the determined guest-ready areas.

### BACKGROUND

### 1. Technical Field

The present disclosure relates to a presenting method that presents a destination to show a person to in a predetermined space that an autonomous cleaner cleans, a presenting device, and a non-transitory computer-readable recording medium storing a presenting program.

### 2. Description of the Related Art

There is, as related art to notify guests in a restaurant or the like of unoccupied tables, a technology that forms a seating state in a manageable form, regarding whether or not tables are unoccupied tables distinguishably in relation with the tables, and whether each of the tables is an unoccupied table or an occupied table, and forms the managed seating state in a visually recognizable manner on a seating display unit, including an unoccupied table to which the guest is shown (e.g., see Japanese Unexamined Patent Application Publication No. 2000-029947).

There also is, as related art regarding a control method of multiple autonomous cleaners using a server, a technology where the server allocates cleaning areas to the multiple autonomous cleaners, and causes the multiple autonomous cleaners to clean efficiently (e.g., see Japanese Patent No. 5,735,940)

### SUMMARY

However, there is no disclosure or suggestion in the related art of showing a person to a predetermined area in a predetermined space, while the autonomous cleaners are cleaning inside the predetermined space.

One non-limiting and exemplary embodiment provides a presenting method, a presenting device, and a non-transitory computer-readable recording medium storing a presenting program, by which, when an autonomous cleaner is cleaning within a predetermined space, a person can be shown to a predetermined area within the predetermined space, taking into consideration the position where the autonomous cleaner is cleaning, and can be shown to an area where the effects of flying dust and noise due to the autonomous cleaner performing cleaning is small.

In one general aspect, the techniques disclosed here feature a presenting method for a presenting device. The method includes: obtaining area information indicating multiple seating target areas, obtained by dividing a predetermined space that an autonomous cleaner cleans into areas to which people are shown; obtaining position information indicating a current position of the autonomous cleaner in the predetermined space; obtaining person-presence information indicating whether or not a person is present in each of the multiple guest-ready areas; deciding a first surrounding area indicating a predetermined range around the autonomous cleaner, based on the current position of the autonomous cleaner that the position information indicates; deciding, of the multiple seating target areas indicated by the area information, the seating target areas not overlapping with the first surrounding area as being guest-ready candidate areas; deciding, of the guest-ready candidate areas, guest-ready candidate areas where there is no person present as being guest-ready areas; and presenting the decided guest-ready areas.

According to the present disclosure, when an autonomous cleaner is cleaning within a predetermined space, a person can be shown to a predetermined area within the predetermined space, taking into consideration the position where the autonomous cleaner is cleaning, and can be shown to an area where the effects of flying dust and noise due to the autonomous cleaner performing cleaning is small.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram conceptually illustrating an overall image of a seating system according to a first embodiment;

FIG. 2 is a block diagram illustrating a functional configuration of a terminal device according to the first embodiment;

FIG. 3 is a diagram illustrating an example of a two-dimensional coordinate system set in floor plan information in the first embodiment;

FIG. 4 is a diagram illustrating an example of table information in the first embodiment;

FIG. 5 is a diagram illustrating superimposed information, where areas indicating tables has been superimposed on the floor plan information in FIG. 3, based on the table information illustrated in FIG. 4;

FIG. 6 is a block diagram illustrating a functional configuration of a management device according to the first embodiment;

FIG. 7 is an external transparent view of an autonomous cleaner according to the first embodiment as viewed from above;

FIG. 8 is a block diagram illustrating the functional configuration of the autonomous cleaner according to the first embodiment;

FIG. 9 is a flowchart for describing processing of the terminal device according to the first embodiment;

FIG. 10 is a diagram illustrating an example of a display screen including an input button to prompt display of guest-ready tables in the first embodiment;

FIG. 11 is a diagram illustrating an example of superimposed information where table information and a surrounding area have been superimposed on floor plan information in the first embodiment;

FIG. 12 is a diagram illustrating an example of a display screen displaying guest-ready tables in the first embodiment;

FIG. 13 is a diagram illustrating an example of a display screen where guest-ready tables are displayed in order from a position the farthest away from the current position of the autonomous cleaner in the first embodiment;

FIG. 14 is a diagram illustrating an example of a display screen, where guest-ready tables and not-guest-ready tables are displayed using different display forms in the first embodiment;

FIG. 15 is a diagram illustrating an example of a display screen where the display forms of guest-ready tables differ in accordance with priority in the first embodiment;

FIG. 16 is a diagram illustrating an example of a display screen where first not-guest-ready tables that are not guest-ready due to not being unoccupied, and second not-guest-ready tables that are unoccupied but are not guest-ready due to overlapping the surrounding area of the autonomous cleaner, are displayed using different forms, in the first embodiment;

FIG. 17 is a diagram illustrating an example of a display screen where surrounding information, decided in accordance with the direction of travel of the autonomous cleaner, is superimposed on the floor plan information in the first embodiment;

FIG. 18 is a diagram illustrating an example of a display screen where a travel route of the autonomous cleaner is superimposed on the floor plan information in the first embodiment;

FIG. 19 is a diagram illustrating an example of a display screen where a surrounding area decided in accordance with the travel route of the autonomous cleaner is superimposed on the floor plan information in the first embodiment;

FIG. 20 is a diagram illustrating an example of a display screen where a cleaned area of the autonomous cleaner is superimposed on the floor plan information in the first embodiment;

FIG. 21 is a diagram illustrating an example of a display screen where guest-ready tables are displayed in a case where multiple cleaning target areas are set beforehand, in the first embodiment;

FIG. 22 is a diagram illustrating an example of surrounding area information stored in a surrounding area information storage unit in a case where multiple cleaning target areas are set beforehand, in the first embodiment;

FIGS. 23A and 23B are diagrams for describing processing of switching the size of the surrounding area in accordance with the state of operation of the autonomous cleaner in the first embodiment;

FIG. 24 is a block diagram illustrating a functional configuration of a terminal device according to a second embodiment;

FIG. 25 is a first flowchart for describing processing by the terminal device in the second embodiment;

FIG. 26 is a second flowchart for describing processing by the terminal device in the second embodiment;

FIG. 27 is a diagram illustrating an example of a display screen displaying superimposed information, a notification message making notification to the effect that there are not guest-ready tables, and a stop button for stopping the autonomous cleaner, in the second embodiment;

FIG. 28 is a diagram illustrating an example of a display screen displaying a selection accepting message prompting selection of an autonomous cleaner to be stopped in the second embodiment;

FIG. 29 is a diagram illustrating an example of a display screen accepting selection of one autonomous cleaner out of multiple autonomous cleaners in the second embodiment;

FIG. 30 is a diagram illustrating an example of a display screen displaying guest-ready tables after having stopped an autonomous cleaner in the second embodiment; and

FIG. 31 is a diagram illustrating an example of a display screen displaying guest-ready tables decided in a case where the size of the surrounding area of an autonomous cleaner that has been stopped is reduced.

### DETAILED DESCRIPTION

### Underlying Knowledge Forming Basis of the Present Disclosure

Japanese Unexamined Patent Application Publication No. 2000-029947 discloses, as related art to notify guests in a restaurant or the like of unoccupied tables, a technology that forms a seating state in a manageable form, regarding whether or not tables are unoccupied tables distinguishably in relation with the tables, and whether each of the tables is an unoccupied table or an occupied table, and forms the managed seating state in a visually recognizable manner on a seating display unit, including an unoccupied table to which the guest is shown.

Japanese Patent No. 5,735,940 discloses, as related art regarding a control method of multiple autonomous cleaners using a server, a technology where the server allocates cleaning areas to the multiple autonomous cleaners, and causes the multiple autonomous cleaners to clean efficiently.

For example, a case of a restaurant that is open 24 hours will be considered. The restaurant has multiple tables, and cleaning areas are set around these tables. An autonomous cleaner is to be used to clean multiple cleaning areas. If a restaurant is open 24 hours, this means that cleaning will take place while the restaurant is open. Accordingly, there is a need to have the autonomous cleaner to clean during a time period when there are few guests in the restaurant and customer traffic is light. Regardless of cleaning during a time period when there are few guests in the restaurant and customer traffic is light, if a guest comes in, that guest needs to be shown to a table.

However, there is no disclosure or suggestion in the related art of showing a person to a predetermined area in a predetermined space while the autonomous cleaner is cleaning inside the predetermined space, taking into consideration the location where this autonomous cleaner is cleaning. If a guest is shown to a table where an autonomous cleaner is cleaning, the autonomous cleaner may inconvenience the guest and make the guest feel uncomfortable.

A presenting method according to a first aspect of the present disclosure is a presenting method including: obtaining area information indicating multiple seating target areas, obtained by dividing a predetermined space that an autonomous cleaner cleans into areas to which people are shown; obtaining position information indicating a current position of the autonomous cleaner in the predetermined space; obtaining person-presence information indicating whether or not a person is present in each of the multiple guest-ready areas; deciding a first surrounding area indicating a predetermined range around the autonomous cleaner, based on the current position of the autonomous cleaner that the position information indicates; deciding, of the multiple seating target areas indicated by the area information, the seating target areas not overlapping with the first surrounding area as being guest-ready candidate areas; deciding, of the guest-ready candidate areas, guest-ready candidate areas where there is no person present as being guest-ready areas; and presenting the decided guest-ready areas.

According to this configuration, area information indicating multiple seating target areas, obtained by dividing a predetermined space that an autonomous cleaner cleans into areas to which people are shown, is obtained. Position information indicating a current position of the autonomous cleaner in the predetermined space is obtained. Person-presence information indicating whether or not a person is present in each of the multiple guest-ready areas is obtained. A first surrounding area indicating a predetermined range around the autonomous cleaner is decided based on the current position of the autonomous cleaner that the position information indicates. Of the multiple seating target areas indicated by the area information, the seating target areas not overlapping with the first surrounding area are decided as being guest-ready candidate areas. Of the guest-ready candidate areas, guest-ready candidate areas where there is no person present are decided as being guest-ready areas. The decided guest-ready areas are presented.

Accordingly, of the multiple seating target areas, seating target areas that do not overlap the first surrounding area around the autonomous cleaner are decided as being guest-ready candidate areas, and of the guest-ready candidate areas, guest-ready candidate areas where no person is present are decided as being guest-ready areas, and the decided guest-ready areas are presented. Accordingly, when the autonomous cleaner is cleaning within the predetermined space, a person can be shown to a predetermined area within the predetermined space, taking into consideration the position where the autonomous cleaner is cleaning, and can be shown to an area where the effects of flying dust and noise due to the autonomous cleaner performing cleaning is small.

The presenting method may further include deciding, of the multiple seating target areas, seating target areas other than the guest-ready tables as being not-guest-ready areas; and displaying the guest-ready areas and not-guest-ready areas using different forms.

According to this configuration, of the multiple seating target areas, seating target areas other than the guest-ready tables are decided as being as being not-guest-ready areas. The guest-ready areas and not-guest-ready areas are displayed using different forms.

Accordingly, guest-ready areas and not-guest-ready areas are displayed using different forms, so the user can easily distinguish between guest-ready areas and not-guest-ready areas.

The presenting method may further include deciding, of the not-guest-ready areas, the seating target areas where a person is present based on the person-presence information, as being first not-guest-ready areas; deciding, of the not-guest-ready areas, the not-guest-ready areas overlapping the first surrounding area as being second not-guest-ready areas that are not guest ready due to overlapping the first surrounding area; and displaying the first not-guest-ready areas and the second not-guest-ready areas using different forms.

According to this configuration, of the not-guest-ready areas, the seating target areas where a person is present based on the person-presence information are decided as being first not-guest-ready areas. Of the not-guest-ready areas, the not-guest-ready areas overlapping the first surrounding area are decided as being second not-guest-ready areas that are not guest ready due to overlapping the first surrounding area. The first not-guest-ready areas and the second not-guest-ready areas are displayed using different forms.

Accordingly, the first not-guest-ready areas, and the second not-guest-ready areas that are not-guest-ready table due to overlapping the first surrounding area, are displayed using different forms, so the user can easily recognize why a guest cannot be shown to the not-guest-ready areas. Also, the second not-guest-ready areas that have no person present but are not guest ready due to overlapping the first surrounding area can be changed into guest-ready areas by stopping the autonomous cleaner, so the user can easily comprehend not-guest-ready areas that can become guest-ready areas by stopping the autonomous cleaner.

The presenting method may further include obtaining degree-of-priority imparting condition information indicating a condition for imparting a degree of priority to each of the multiple guest-ready areas in a case where multiple guest-ready areas have been decided as the guest-ready areas; imparting, in a case where multiple guest-ready areas have been decided, degree of priority to each of the multiple guest-ready areas, based on the degree-of-priority imparting condition information; and displaying the multiple guest-ready areas using different forms based on the degree of priority.

According to this configuration, degree-of-priority imparting condition information, indicating a condition for imparting a degree of priority to each of the multiple guest-ready areas in a case where multiple guest-ready areas have been decided as the guest-ready areas, is obtained. In a case where multiple guest-ready areas have been decided, degree of priority is imparted to each of the multiple guest-ready areas, based on the degree-of-priority imparting condition information. The multiple guest-ready areas are displayed using different forms based on the degree of priority.

Accordingly, the multiple guest-ready areas are displayed using different forms based on the degree of priority, so the user can easily decide a guest-ready table to guide a guest to.

In the presenting method, the degree-of-priority imparting condition information may include a condition of imparting a high degree of priority in order from the guest-ready area that is farthest away from the current position of the autonomous cleaner.

According to this configuration, a high degree of priority is imparted in order from the guest-ready area that is farthest away from the current position of the autonomous cleaner, so the user can guide a person to a guest-ready area where the effects of flying dust and noise due to cleaning by the autonomous cleaner are the smallest.

In the presenting method, the degree-of-priority imparting condition information may include a condition of imparting a high degree of priority in order from the guest-ready area regarding which the time of day of the autonomous cleaner having completed cleaning is the most recent.

According to this configuration a high degree of priority is imparted in order from the guest-ready area regarding which the time of day of the autonomous cleaner having completed cleaning is the most recent, so the user can guide a person to a guest-ready area where there is the least amount of dust accumulated.

In the presenting method, the multiple guest-ready areas are displayed in descending order of degree of priority.

According to this configuration, the multiple guest-ready areas are displayed in descending order of degree of priority, so the user can visually comprehend guest-ready areas with different degrees of priority.

The presenting method may further include obtaining state information indicating an operating state of the autonomous cleaner; and deciding, from the multiple seating target areas, the seating target areas that do not overlap the first surrounding area as being the guest-ready candidate areas, only in a case where the operating state of the autonomous cleaner is performing cleaning operations.

According to this configuration, state information indicating an operating state of the autonomous cleaner is obtained. The seating target areas that do not overlap the first surrounding area are decided as being the guest-ready candidate areas from the multiple seating target areas only in a case where the operating state of the autonomous cleaner is performing cleaning operations.

Accordingly, in a case where the operating state of the autonomous cleaner is other than performing cleaning operations, there is no dust flying or noise being made around the autonomous cleaner, so the user can show a person to the vicinity of the autonomous cleaner of which the operating state is other than performing cleaning operations.

The presenting method may further include deciding, in a case where the operating state of the autonomous cleaner is other than performing cleaning operations, a second surrounding area that represents a predetermined range from the current position of the autonomous cleaner based on the position information, and that also is smaller than the first surrounding area; and deciding, of the multiple seating target areas, the seating target areas not overlapping the second surrounding area as being guest-ready candidate areas.

According to this configuration, in a case where the operating state of the autonomous cleaner is other than performing cleaning operations, a second surrounding area is decided that represents a predetermined range from the current position of the autonomous cleaner based on the position information, and that also is smaller than the first surrounding area. Of the multiple seating target areas, the seating target areas not overlapping the second surrounding area are decided as being guest-ready candidate areas.

Accordingly, the autonomous cleaner of which the operating state is other than performing cleaning operations, and which is not performing cleaning operations, can be prevented from inconveniencing the guided person.

The presenting method may further include periodically obtaining the position device and the person-presence information from an external device; and periodically updating the presented guest-ready areas.

According to this configuration, the position information and the person-presence information are periodically obtained from an external device. The presented guest-ready areas are periodically updated.

Accordingly, the position of the autonomous cleaner and the position where a person is present can be periodically comprehended, and the user can simulate beforehand which guest-ready areas people can be shown to when actually showing people to the guest-ready areas. Thus, when a person actually is to be shown to a guest-ready area, the user can immediately decide which guest-ready area to show the person to.

The presenting method may further include obtaining person detection information indicating that a person has entered the predetermined space; and updating the presented guest-ready areas in a case of having obtained the person detection information.

According to this configuration, person detection information indicating that a person has entered the predetermined space is obtained. The presented guest-ready areas are updated in a case of having obtained the person detection information.

Accordingly, the newest guest-ready areas can be presented at the timing of a person entering the predetermined space.

The presenting method may further include transmitting control information to stop cleaning by the autonomous cleaner in a case of having accepted input from a user instructing stopping cleaning by the autonomous cleaner; and re-deciding the multiple seating target areas as being the guest-ready candidate areas, without deciding the first surrounding area around the autonomous cleaner that has been made to stop cleaning.

According to this configuration, control information to stop cleaning by the autonomous cleaner is transmitted in a case of having accepted input from a user instructing stopping cleaning by the autonomous cleaner. The multiple seating target areas are re-decided as guest-ready candidate areas, without deciding the first surrounding area around the autonomous cleaner that has been made to stop cleaning.

Accordingly, the guest-ready candidate areas are re-decided after having stopped the autonomous cleaner, so guest-ready candidate areas where no people are present and that no longer overlap the first surrounding area around the autonomous cleaner can be presented to the user.

A presenting device according to another aspect of the present disclosure is a presenting device including processing circuitry; and storage including at least one set of instructions that, when executed by the processing circuitry, cause the processing circuitry to perform operations including obtaining area information indicating multiple seating target areas, obtained by dividing a predetermined space that an autonomous cleaner cleans into areas to which people are shown, obtaining position information indicating a current position of the autonomous cleaner in the predetermined space, obtaining person-presence information indicating whether or not a person is present in each of the multiple guest-ready areas, deciding a first surrounding area indicating a predetermined range around the autonomous cleaner, based on the current position of the autonomous cleaner that the position information indicates, deciding, of the multiple seating target areas indicated by the area information, the seating target areas not overlapping with the first surrounding area as being guest-ready candidate areas, deciding, of the guest-ready candidate areas, guest-ready candidate areas where there is no person present as being guest-ready areas, and presenting the decided guest-ready areas.

According to this configuration, area information indicating multiple seating target areas, obtained by dividing a predetermined space that an autonomous cleaner cleans into areas to which people are shown, is obtained. Position information indicating a current position of the autonomous cleaner in the predetermined space is obtained. Person-presence information indicating whether or not a person is present in each of the multiple guest-ready areas is obtained. A first surrounding area indicating a predetermined range around the autonomous cleaner is decided based on the current position of the autonomous cleaner that the position information indicates. Of the multiple seating target areas indicated by the area information, the seating target areas not overlapping with the first surrounding area are decided as being guest-ready candidate areas. Of the guest-ready candidate areas, guest-ready candidate areas where there is no person present are decided as being guest-ready areas. The decided guest-ready areas are presented.

Accordingly, of the multiple seating target areas, seating target areas that do not overlap the first surrounding area around the autonomous cleaner are decided as being guest-ready candidate areas, and of the guest-ready candidate areas, guest-ready candidate areas where no person is present are decided as being guest-ready areas, and the decided guest-ready areas are presented. Accordingly, when the autonomous cleaner is cleaning within the predetermined space, a person can be shown to a predetermined area within the predetermined space, taking into consideration the position where the autonomous cleaner is cleaning, and can be shown to an area where the effects of flying dust and noise due to the autonomous cleaner performing cleaning is small.

A non-transitory computer-readable recording medium according to another aspect of the present disclosure is a non-transitory computer-readable recording medium storing a program, that when executed by a computer, causes the computer to execute a method including obtaining area information indicating multiple seating target areas, obtained by dividing a predetermined space that an autonomous cleaner cleans into areas to which people are shown, obtaining position information indicating a current position of the autonomous cleaner in the predetermined space, obtaining person-presence information indicating whether or not a person is present in each of the multiple guest-ready areas, deciding a first surrounding area indicating a predetermined range around the autonomous cleaner, based on the current position of the autonomous cleaner that the position information indicates, deciding, of the multiple seating target areas indicated by the area information, the seating target areas not overlapping with the first surrounding area as being guest-ready candidate areas, deciding, of the guest-ready candidate areas, guest-ready candidate areas where there is no person present as being guest-ready areas, and presenting the decided guest-ready areas.

According to this configuration, area information indicating multiple seating target areas, obtained by dividing a predetermined space that an autonomous cleaner cleans into areas to which people are shown, is obtained. Position information indicating a current position of the autonomous cleaner in the predetermined space is obtained. Person-presence information indicating whether or not a person is present in each of the multiple guest-ready areas is obtained. A first surrounding area indicating a predetermined range around the autonomous cleaner is decided based on the current position of the autonomous cleaner that the position information indicates. Of the multiple seating target areas indicated by the area information, the seating target areas not overlapping with the first surrounding area are decided as being guest-ready candidate areas. Of the guest-ready candidate areas, guest-ready candidate areas where there is no person present are decided as being guest-ready areas. The decided guest-ready areas are presented.

Accordingly, of the multiple seating target areas, seating target areas that do not overlap the first surrounding area around the autonomous cleaner are decided as being guest-ready candidate areas, and of the guest-ready candidate areas, guest-ready candidate areas where no person is present are decided as being guest-ready areas, and the decided guest-ready areas are presented. Accordingly, when the autonomous cleaner is cleaning within the predetermined space, a person can be shown to a predetermined area within the predetermined space, taking into consideration the position where the autonomous cleaner is cleaning, and can be shown to an area where the effects of flying dust and noise due to the autonomous cleaner performing cleaning is small.

Embodiments of the present disclosure will be described below with reference to the drawings. Note that the embodiments below are exemplary specific forms of the present disclosure, and do not restrict the technical scope of the present disclosure.

### First Embodiment

In the first embodiment, description will be made regarding a method where, in a situation where a guest comes into an eatery where an autonomous cleaner is cleaning, a guest-ready table where the effects of flying dust and noise from the cleaning by the autonomous cleaner is small is presented on a terminal device that an employee carries.

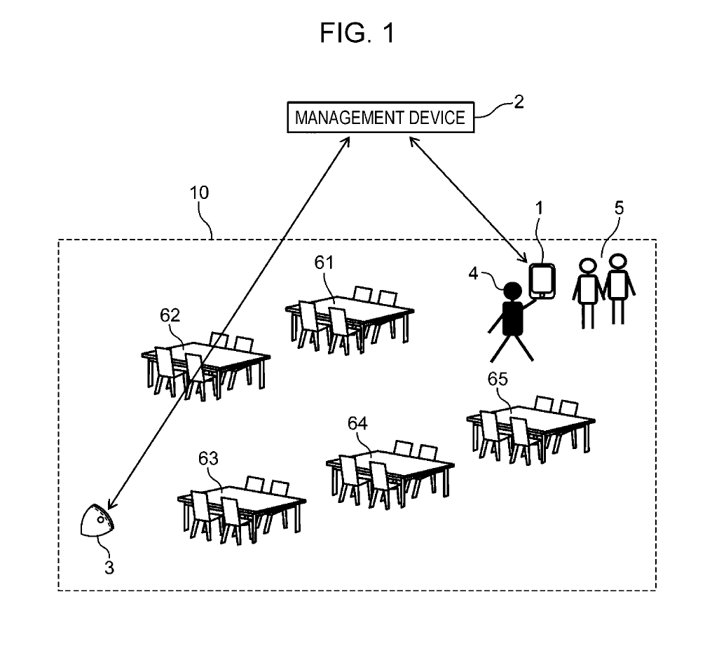

FIG. 1 is a diagram conceptually illustrating an overall image of a seating system according to a first embodiment. The seating system illustrated in FIG. 1 has a terminal device 1 that an employee 4 carries, an autonomous cleaner 3, and a management device 2 outside of the eatery 10. Multiple tables 61 through 65 are placed in the eatery 10. The seating system displays guest-ready tables on the terminal device 1 that the employee 4 carries in a case where a guest arrives while the autonomous cleaner 3 is cleaning inside the eatery 10.

The terminal device 1 is, for example, a personal digital assistant (PDA) integrated with a portable data terminal, a smartphone, a tablet computer, or the like. Although the terminal device 1 is described as a terminal that the employee 4 carries in the first embodiment, this does not necessarily have to be a terminal that the employee 4 carries. The terminal device 1 may be, for example, a terminal installed in the eatery 10, such as a personal computer or the like.

The terminal device 1 first requests the management device 2 for floor plan information indicating the floor plan of the eatery 10, table information indicating the placement and sizes of tables in the eatery 10, position information indicating the current position of the autonomous cleaner 3, and unoccupied table information indicating whether guests are present at the tables, and receives this information from the management device 2. The terminal device 1 then generates superimposed information where table information, and a surrounding area around the autonomous cleaner 3, based on the position information of the autonomous cleaner 3, are superimposed on the floor plan. The terminal device 1 decides tables in the generated superimposed information that are in areas other than the surrounding area of the autonomous cleaner 3 to be guest-ready candidate tables. Based on the unoccupied table information, the terminal device 1 decides guest-ready candidate tables that have been decided and that are unoccupied to be guest-ready tables, which are displayed on the display unit of the terminal device 1.

The management device 2 is a server, for example, and is installed inside or outside of the eatery. An example where the management device 2 is installed outside of the eatery is illustrated in the first embodiment. The management device 2 transmits the floor plan information, table information, position information of the autonomous cleaner 3, and unoccupied table information that it stores, to the terminal device 1, upon request from the terminal device 1. The floor plan information, table information, position information of the autonomous cleaner 3, and unoccupied table information that the management device 2 stores will be described later in detail.

The autonomous cleaner 3 cleans cleaning areas based on cleaning instruction information received from the management device 2. The autonomous cleaner 3 also transmits position information, cleaning history, and so forth, of the autonomous cleaner 3, to the management device 2.

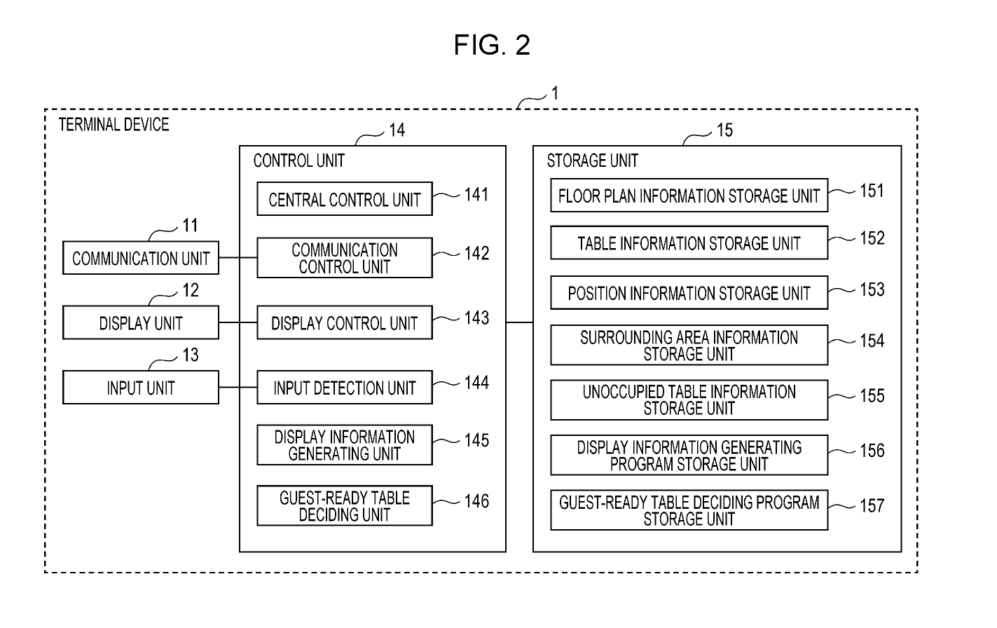

The configuration of the terminal device 1, management device 2, and autonomous cleaner 3 will be described below in detail. FIG. 2 is a block diagram illustrating the functional configuration of the terminal device 1 in the first embodiment. The terminal device 1 includes a communication unit 11, a display unit 12, an input unit 13, a control unit 14, and a storage unit 15.

The communication unit 11 performs communication with an external device such as the management device 2, and exchanges information. The communication unit 11 exchanges information via a local area network (LAN) or wide area network (WAN), for example. As an example, the communication unit 11 transmits a request for the floor plan information, table information, position information of the autonomous cleaner 3, and unoccupied table information, to the management device 2, and receives the floor plan information, table information, position information of the autonomous cleaner 3, and unoccupied table information, from the management device 2.

The communication unit 11 receives the floor plan information indicating the floor plan of the predetermined space. The communication unit 11 receives table information (area information) indicating multiple seating target tables (seating target areas) obtained by dividing the predetermined space that the autonomous cleaner 3 cleans into areas to which people are shown. The communication unit 11 receives position information indicating the current position of the autonomous cleaner 3 in the predetermined space. The communication unit 11 receives unoccupied table information (person-presence information) indicating whether or not people are present at each of the multiple seating target tables (seating target areas).

The display unit 12 displays information to a user such as the employee 4. The display unit 12 is configured of a liquid crystal display, for example. In a case where a guest arrives, the display unit 12 displays guest-ready tables to the employee 4.

The input unit 13 accepts input from the user such as the employee 4. The input unit 13 is configured of a touchscreen or operating panel or the like that has been integrated with the display unit 12, for example. The input unit 13 accepts input from the employee 4 to the terminal device 1, prompting start of displaying guest-ready tables when a guest arrives.

The control unit 14 is a central processing unit (CPU) for example, and has a central control unit 141, a communication control unit 142, a display control unit 143, an input detection unit 144, a display information generating unit 145, and a guest-ready table deciding unit 146. The central control unit 141 controls storage of information to the storage unit 15, control between the control components of the control unit 14, and so forth.

The communication control unit 142 controls the communication unit 11 when requesting the management device 2 for transmission of the floor plan information, table information, position information of the autonomous cleaner 3, and unoccupied table information, receiving the floor plan information, table information, position information of the autonomous cleaner 3, and unoccupied table information from the management device 2, and so forth. The communication control unit 142 obtains floor plan information, table information (area information), position information, and unoccupied table information (person-presence information). Note that the communication control unit 142 is equivalent to an example of a first obtaining unit, a second obtaining unit, and a third obtaining unit.

The display control unit 143 controls the display unit 12 when displaying display information generated at the display information generating unit 145 on the display unit 12. For example, when a guest arrives and guest-ready tables are to be displayed for the employee 4, the display control unit 143 displays information of guest-ready tables on the display unit 12.

The display information generating unit 145 generates information to be displayed on the display unit 12. For example, the display information generating unit 145 generates information of guest-ready tables to be displayed for the employee 4.

The input detection unit 144 detects input by the user to the input unit 13. For example, in a case where a guest has arrived and the employee 4 has pressed a button to prompt display of guest-ready tables, the input detection unit 144 detects the button input performed by the employee 4.

The guest-ready table deciding unit 146 decides guest-ready tables to be presented to the employee 4. The guest-ready table deciding unit 146 decides a surrounding area (first surrounding area) around the autonomous cleaner 3, based on the current position of the autonomous cleaner 3 that the position information indicates. Of the multiple seating target tables (seating target areas) that the table information (area information) indicates, the guest-ready table deciding unit 146 decides seating target tables that do not overlap the surrounding area to be guest-ready candidate tables (guest-ready candidate areas). Of the guest-ready candidate tables, the guest-ready table deciding unit 146 decides guest-ready candidate tables where there are no people present to be guest-ready tables (guest-ready areas).

Specifically, the guest-ready table deciding unit 146 first generates superimposed information, where the table information and the surrounding area of the autonomous cleaner 3 based on the position information of the autonomous cleaner 3 are superimposed on the floor plan information, based on the floor plan information, table information, and position information of the autonomous cleaner 3 received from the management device 2. The guest-ready table deciding unit 146 next decides tables in the generated superimposed information that are in areas other than the surrounding area of the autonomous cleaner 3 to be guest-ready candidate tables. Based on the unoccupied table information, the guest-ready table deciding unit 146 decides guest-ready candidate tables that have been decided and that are unoccupied to be guest-ready tables. Note that the guest-ready table deciding unit 146 is equivalent to an example of a surrounding area deciding unit, a guest-ready candidate area deciding unit, and guest-ready area deciding unit.

The storage unit 15 is semiconductor memory, for example, and includes a floor plan information storage unit 151, a table information storage unit 152, a position information storage unit 153, a surrounding area information storage unit 154, an unoccupied table information storage unit 155, a display information generating program storage unit 156, and a guest-ready table deciding program storage unit 157.

The floor plan information storage unit 151 stores floor plan information transmitted from the management device 2. The floor plan information here stores map information indicating the entirety of areas to be cleaned. This floor plan information is a plane view of the layout and shape of one or more rooms making of a predetermined space of a shop or the like, in planar form. The map information indicating the entirety of areas to be cleaned in the first embodiment is information indicating the floor plan of the eatery 10. The floor plan information is stored before operating the system, by obtaining the floor plan information created when designing the eatery 10 from a server or the like. Any method of obtaining floor plan information may be used at this time. For example, an autonomous cleaner 3 having a map creating function may create map information of the inside of the eatery while traveling through the eatery, which may be stored. Still images taken from above, such as the ceiling of the shop or the like, may be used as floor plan information.

The table information storage unit 152 stores table information transmitted by the management device 2. The table information includes table identification information, table position information, and table area information. The table identification information is information for uniquely identifying each table. Table position information indicates the position of the table in the floor plan information. For example, a two-dimensional coordinate system may be set beforehand in the floor plan information, with table position information being expressed in terms of coordinate information in the two-dimensional coordinate system.

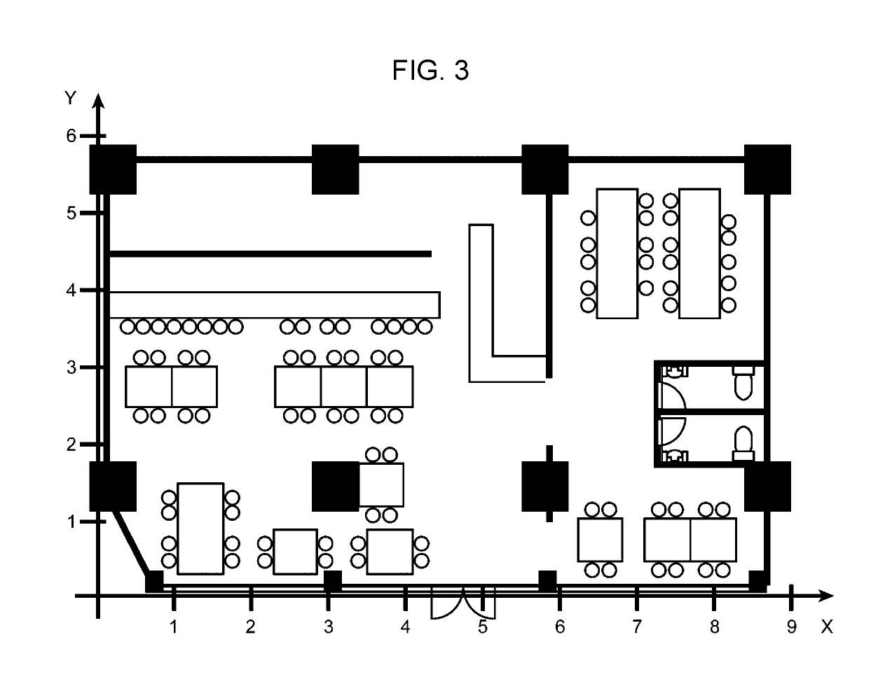

FIG. 3 is a diagram illustrating an example of a two-dimensional coordinate system set in the floor plan information. The tables in FIG. 3 are illustrated as areas made up of dining tables and chairs, and an optional point in such an area can be set as position information of the table. However, which point in the area is to be used as position information of the table needs to be decided beforehand. Table area information is information indicating the shape and/or geometric area of an area. An example is to say that the shape of the area is circular, and the geometric area is five square meters. In the configuration illustrated in the first embodiment, an example is illustrated where the areas representing tables are rectangular shapes, and the vertices at the lower left corner of the rectangles are the table position information.

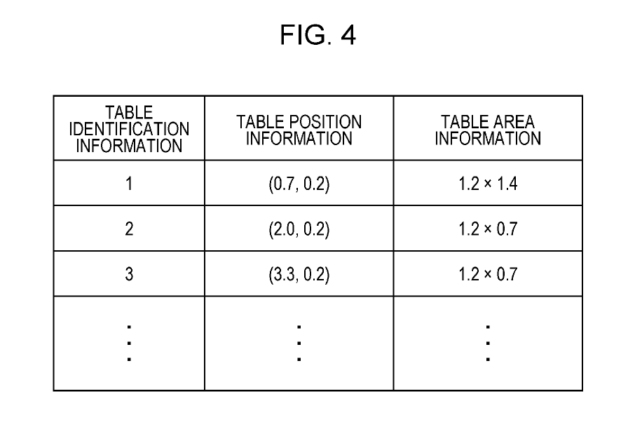

FIG. 4 is a diagram illustrating an example of table information in the first embodiment. The table information illustrated in FIG. 4 includes table identification information of the tables, the table position information of the tables based on the two-dimensional coordinate system in the floor plan in FIG. 3, and table area information of the tables. The table identification information is expressed in the form of identification numbers, to uniquely identify the tables. The table area information is expressed by the length in the lateral direction (x direction) and the length in the longitudinal direction (y direction).

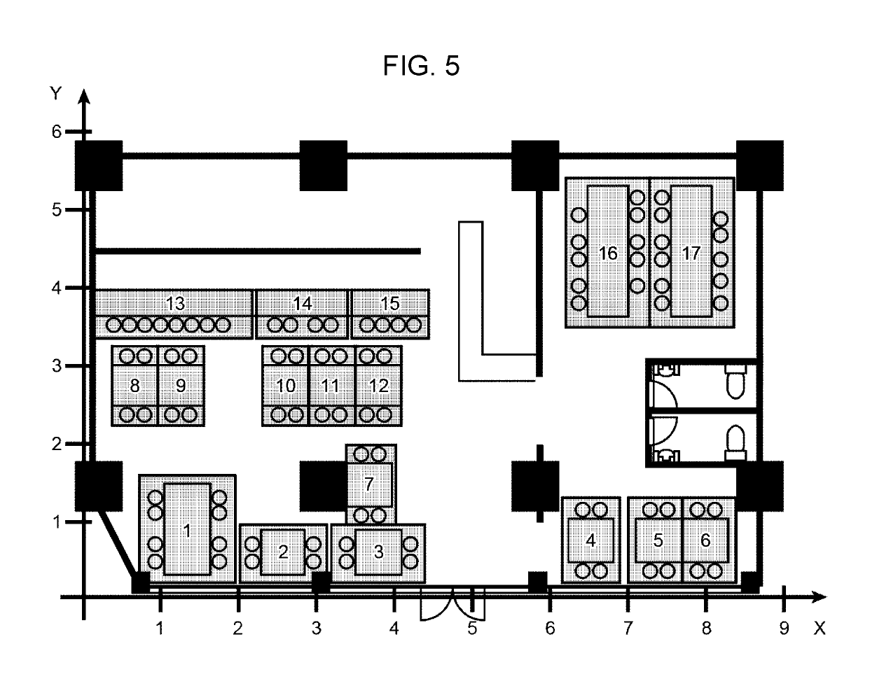

FIG. 5 is a diagram illustrating superimposed information where the areas representing the tables are superimposed on the floor plan information in FIG. 3, based on the table information illustrated in FIG. 4. Areas indicating the tables are superimposed on the floor plan, as illustrated in FIG. 5.

The position information storage unit 153 stores position information of the autonomous cleaner 3 that has been received from the management device 2. It is sufficient for the position information of the autonomous cleaner 3 to be information that enables information of the position of the autonomous cleaner 3 in the floor plan information to be identified, since it is used to superimpose the current position of the autonomous cleaner 3 on the floor plan information. For example, in a case where a two-dimensional coordinate system is set in the floor plan information beforehand, the position of the autonomous cleaner 3 in the floor plan information can be identified by representing the position information of the autonomous cleaner 3 by coordinates in the two-dimensional coordinate system. As another example, a camera (omitted from illustration) may be installed so as to be able to shoot floor plan information from above, such as on the ceiling of the building or the like, and information taken of the autonomous cleaner 3 by that camera may be used as the position information of the autonomous cleaner 3. In this case as well, the position of the autonomous cleaner 3 in the floor plan information can be identified.

The surrounding area information storage unit 154 stores surrounding area information for deciding a surrounding area round the current position of the autonomous cleaner 3. For example, in a case of taking an area within a predetermined distance range from the current position of the autonomous cleaner 3 as the surrounding area, the surrounding area information indicates a predetermined distance. In this case, the position information of the autonomous cleaner 3 is obtained from the management device 2, so the guest-ready table deciding unit 146 can decide the surrounding area of the autonomous cleaner 3 based on the position information of the autonomous cleaner 3 and the predetermined distance stored in the surrounding area information storage unit 154.

Although the surrounding area information storage unit 154 stores information indicating the predetermined distance in the first embodiment, information indicating a circle of which the radius is the predetermined distance may be stored instead of information indicating the predetermined distance. In the case of the is configuration, the guest-ready table deciding unit 146 can decide an area where the current position of the autonomous cleaner 3 and the center of the circle are matched as the surrounding area of the autonomous cleaner 3, based on the stored information indicating the circle, and the position information of the autonomous cleaner 3. Although the surrounding area has been described as being circular in shape, but other shapes may be used. The surrounding area information may be obtained from the management device 2, or may be created by the user. The surrounding area information in the first embodiment is information that is set by the user beforehand, and is stored beforehand.

The unoccupied table information storage unit 155 stores unoccupied table information obtained from the management device 2. Unoccupied table information is information indicating tables where no guests are, out of all tables. The unoccupied table information storage unit 155 stores table identification information to identify tables where there is nobody.

The display information generating program storage unit 156 stores a display information generating program for generating information to display on the display unit 12. The display information generating program is executed by the display information generating unit 145. The display information generating program may be stored in the display information generating program storage unit 156 by being installed by the user beforehand, or may be stored in the display information generating program storage unit 156 by being downloaded from the management device 2.

The guest-ready table deciding program storage unit 157 stores a guest-ready table deciding program that decides guest-ready tables based on the position information of the autonomous cleaner 3 and unoccupied table information. The guest-ready table deciding program is executed by the guest-ready table deciding unit 146. The guest-ready table deciding program may be stored in the guest-ready table deciding program storage unit 157 by being installed by the user beforehand, or may be stored in the guest-ready table deciding program storage unit 157 by being downloaded from the management device 2.

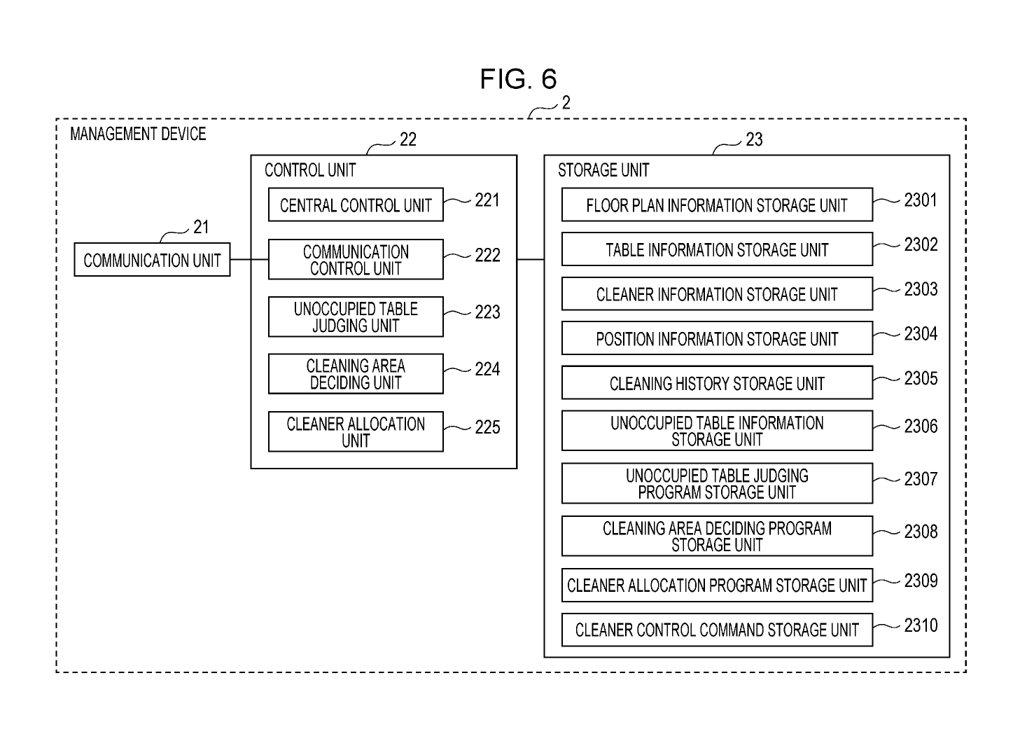

FIG. 6 is a block diagram illustrating the functional configuration of the management device 2 according to the first embodiment. The management device 2 includes a communication unit 21, a control unit 22, and a storage unit 23.

The communication unit 21 exchanges information with external devices, such as transmitting floor plan information, table information, position information of the autonomous cleaner 3, and unoccupied table information to the terminal device 1, transmitting cleaning instruction information to the autonomous cleaner 3, receiving position information from the autonomous cleaner 3, and so forth. The communication unit 21 exchanges information over a LAN or WAN, for example.

The control unit 22 is a CPU for example, and includes a central control unit 221, a communication control unit 222, an unoccupied table judging unit 223, a cleaning area deciding unit 224, and a cleaner allocation unit 225. The central control unit 221 controls storage of information to the storage unit 23, control among control components of the control unit 22, and so forth. The communication control unit 222 controls communication by the communication unit 21, such as transmitting floor plan information, table information, position information of the autonomous cleaner 3, and unoccupied table information to the terminal device 1, transmitting cleaning instruction information to the autonomous cleaner 3, receiving position information from the autonomous cleaner 3, and so forth.

The unoccupied table judging unit 223 judges whether or not each of the tables in the eatery are unoccupied. For example, the management device 2 judges whether or not each of the tables are unoccupied, using order information received from a portable data terminal (omitted from illustration) that an employee carries, and payment information received from a point of sales (POS) cash register (omitted from illustration). Specifically, the unoccupied table judging unit 223 extracts the newest order information from the order information received from the portable data terminal that the employee carries. The unoccupied table judging unit 223 then judges whether or not order identification that is the same as the order identification information included in the extracted order information exists in payment information received from the POS cash register. In a case where the same order identification information is judged to be in the payment information, this means that the guest has already paid, so the unoccupied table judging unit 223 judges that the table is unoccupied (there is nobody present). On the other hand, in a case where the same order identification information is judged not to be in the payment information, this means that the guest has not paid yet, so the unoccupied table judging unit 223 judges that the table is not unoccupied (there is a person present).

Note that the method for unoccupied table judgment is not restricted to this method. Unoccupied table judgment may be performed using other configurations. As another method for performing unoccupied table judgment, for example, a camera (omitted from illustration) may shoot the tables, and the unoccupied table judging unit 223 may judge whether or not there are people by performing pattern matching of people in images shot by the camera, and judge whether or not the tables are unoccupied, based on the results of this judgement. Alternatively, as another method for performing unoccupied table judgment, human sensors (omitted from illustration) such as infrared sensors or the like may be installed at the tables, with the unoccupied table judging unit 223 judging whether or not a person is present based on information from the human sensors, and judge whether or not the tables are unoccupied, based on the results of this judgement. Further, as another method for unoccupied table judgement, pressure sensors (omitted from illustration) may be installed in the seat faces of seats at the tables, and the unoccupied table judging unit 223 may judge whether or not a person is present based on information from the pressure sensors, and judge whether or not the tables are unoccupied, based on the results of this judgement. Moreover, these methods for unoccupied table judgement may be combined for the unoccupied table judging unit 223 to judge whether or not the tables are unoccupied tables.

The cleaning area deciding unit 224 decides a cleaning area for the autonomous cleaner 3 to clean. For example, in a case of setting a two-dimensional coordinate system in the floor plan information, and dividing the floor plan information into multiple cleaning target areas based on the two-dimensional coordinate system, the cleaning area deciding unit 224 decides uncleaned cleaning target areas to be cleaning areas. Further, based on unoccupied table information, the cleaning area deciding unit 224 may decide cleaning target areas that are unoccupied tables out of the uncleaned cleaning target areas to be cleaning areas.

The cleaner allocation unit 225 allocates the autonomous cleaner 3 to the cleaning area that has been decided by the cleaning area deciding unit 224. Specifically, the cleaner allocation unit 225 generates cleaning instruction information to cause the autonomous cleaner 3 to clean the cleaning area decided by the cleaning area deciding unit 224, and transmits the generated cleaning instruction information to the autonomous cleaner 3.

The storage unit 23 is semiconductor memory for example, and includes a floor plan information storage unit 2301, a table information storage unit 2302, a cleaner information storage unit 2303, a position information storage unit 2304, a cleaning history storage unit 2305, an unoccupied table information storage unit 2306, an unoccupied table judging program storage unit 2307, a cleaning area deciding program storage unit 2308, a cleaner allocation program storage unit 2309, and a cleaner control command storage unit 2310.

The floor plan information storage unit 2301 stores floor plan information, which is map information illustrating the entirety of areas that are to be cleaned. The floor plan information in the first embodiment is information indicating the floor plan of the eatery 10. The communication control unit 222 obtains the floor plan information created when designing the eatery 10, for example, from an external server or the like, and stores this in the floor plan information storage unit 2301 before operating the seating system. Any method of obtaining floor plan information may be used at this time. For example, the floor plan information storage unit 2301 may store floor plan information created by an autonomous cleaner 3 having a map creating function by traveling through the eatery. The floor plan information storage unit 2301 may also use still images taken by the camera from above, such as the ceiling of the shop or the like, as floor plan information.

The table information storage unit 2302 stores table information relating to the tables. The table information includes table identification information, table position information, and table area information. Table identification information is information for uniquely identifying each table. Table position information indicates the position of the table in the floor plan information. For example, table position information may be expressed in terms of coordinate information in the two-dimensional coordinate system set in the floor plan information beforehand. The tables are areas made up of dining tables and chairs, and an optional point in such an area can be set as position information of the table. However, which point in the area is to be used as position information of the table needs to be decided beforehand. Table area information is information indicating the shape and/or geometric area of an area. An example is to say that the shape of the area is circular, and the geometric area is one square meter. The table identification information, table position information, and table area information are decided beforehand by the user, and stored.

Although floor plan information and table information are stored separately in the first embodiment, information where the table information has been superimposed on the floor plan information may be stored. For example, still images taken by a camera from above, such as the ceiling of the building, can be deemed to be information where table information has been superimposed on floor plan information, so the information where table information has been superimposed on floor plan information may be stored. In the case of this configuration, the management device 2 transmits the information where table information has been superimposed on floor plan information to the terminal device 1.

The cleaner information storage unit 2303 stores information relating to the autonomous cleaner 3. Information relating to the autonomous cleaner 3 includes identification information of the autonomous cleaner 3 to uniquely identify the autonomous cleaner 3, and address information of the autonomous cleaner 3 to establish communication with the autonomous cleaner 3, for example. The information relating to the autonomous cleaner 3 is used by the cleaner allocation unit 225 to decide which autonomous cleaner 3 to allocate a cleaning area. The information relating to the autonomous cleaner 3 is stored by the user performing settings at the management device 2. As for another example, the address of the management device 2 may be set to the autonomous cleaner 3 beforehand, with the autonomous cleaner 3 transmitting information relating to the autonomous cleaner 3 to the management device 2, and the management device 2 receiving and storing the information relating to the autonomous cleaner 3.

The position information storage unit 2304 stores position information of the autonomous cleaner 3. It is sufficient for the position information of the autonomous cleaner 3 to be information that enables information of the position of the autonomous cleaner 3 in the floor plan information to be identified, since it is used to superimpose the current position of the autonomous cleaner 3 on the floor plan information. For example, in a case where a two-dimensional coordinate system is set in the floor plan information beforehand, the position of the autonomous cleaner 3 in the floor plan information can be identified by representing the position information of the autonomous cleaner 3 by coordinates in the two-dimensional coordinate system. As another example, a camera may be installed so as to be able to shoot floor plan information from above, such as on the ceiling of the building or the like, and information taken of the autonomous cleaner 3 by that camera may be used as the position information of the autonomous cleaner 3. In this case as well, the position of the autonomous cleaner 3 in the floor plan information can be identified.

As another example, the autonomous cleaner 3 may identify its own position in the floor plan information and transmit information of the identified position to the management device 2, whereby the management device 2 can identify the position information of the autonomous cleaner 3 in the floor plan information. In order for the autonomous cleaner 3 to identify its own position in the floor plan information, the positions of obstacles around the autonomous cleaner 3 are identified by obstacle sensors or collision sensors included in the sensor unit of the autonomous cleaner 3 and by camera images, and the identified obstacles are subjected to pattern matching, thereby identifying where in the floor plan information that the autonomous cleaner 3 is. In this case, there is a need to store patterns for identifying obstacles beforehand.

As another method, in a case where the initial position of the autonomous cleaner 3 is included in the floor plan information beforehand, at which position in the floor plan information the autonomous cleaner 3 is can be identified based on how far the autonomous cleaner 3 has traveled in which direction from the initial position. Which direction the autonomous cleaner 3 has traveled in can be identified by a gyro sensor. Also, how far the autonomous cleaner 3 has traveled can be identified by a traveling sensor.

Also, as another method, in a case where the autonomous cleaner 3 is cleaning a cleaning area specified by the management device 2, the specified cleaning area can be identified as the position of the autonomous cleaner 3, since the autonomous cleaner 3 is performing cleaning at the specified cleaning area. In the case of this configuration, the detection precision of the position of the autonomous cleaner 3 is low, but the position of the autonomous cleaner 3 can be detected by a simple configuration. Although the autonomous cleaner 3 identifies the position information here, an arrangement may be made where the autonomous cleaner 3 transmits information that the autonomous cleaner 3 has sensed to the management device 2, and the management device 2 identifies the position of the autonomous cleaner 3 based on the received information. In a case where the autonomous cleaner 3 transmits the position information of itself to the management device 2, the autonomous cleaner 3 may periodically transmit position information to the management device 2, or may transmit when there is a request from the management device 2.

The cleaning history storage unit 2305 stores history of the autonomous cleaner 3 performing cleaning. In the first embodiment, the management device 2 decides cleaning areas for the autonomous cleaner 3 to clean, and causes the autonomous cleaner 3 to clean the decided cleaning areas. Accordingly, the cleaning history information includes information such as the time of day at which the autonomous cleaner 3 was allocated to a cleaning area, the time of day at which the autonomous cleaner 3 started cleaning the cleaning area, the time of day at which the autonomous cleaner 3 completed cleaning of the cleaning area, information indicating the state of progress of cleaning by the autonomous cleaner 3, and so forth, for example. In this case, the time of day at which the autonomous cleaner 3 started cleaning of the cleaning area, the time of day at which the autonomous cleaner 3 completed cleaning of the cleaning area, and information indicating the state of progress of cleaning by the autonomous cleaner 3, are obtained from the autonomous cleaner 3 and stored. In a case of deeming the path over which the autonomous cleaner 3 has traveled as the location where the cleaning ended, for example, the information indicating the state of progress of cleaning is information indicating the percentage of all cleaning areas specified by the management device 2 regarding which traveling has already been completed.

The unoccupied table information storage unit 2306 stores information of tables judged by the unoccupied table judging unit 223 to be unoccupied tables.

The unoccupied table judging program storage unit 2307 stores an unoccupied table judging program that judges whether each of the tables in the eatery is an unoccupied table or not. The unoccupied table judging program is executed by the unoccupied table judging unit 223.

The cleaning area deciding program storage unit 2308 stores a cleaning area deciding program that decides cleaning areas for the autonomous cleaner 3 to clean. The cleaning area deciding program is executed by the cleaning area deciding unit 224.

The cleaner allocation program storage unit 2309 stores a cleaner allocation program for allocating the autonomous cleaner 3 to the cleaning area decided by the cleaning area deciding unit 224. The cleaner allocation program is executed by the cleaner allocation unit 225.

The cleaner control command storage unit 2310 stores command information for controlling the autonomous cleaner 3. For example, the cleaner control command storage unit 2310 stores command information for causing the autonomous cleaner 3 to clean the cleaning area allocated by the cleaner allocation unit 225. Additionally, the cleaner control command storage unit 2310 also stores command information for causing the autonomous cleaner 3 to stop cleaning, command information for causing the autonomous cleaner 3 to travel to a predetermined position such as the initial position or the like, and so forth.

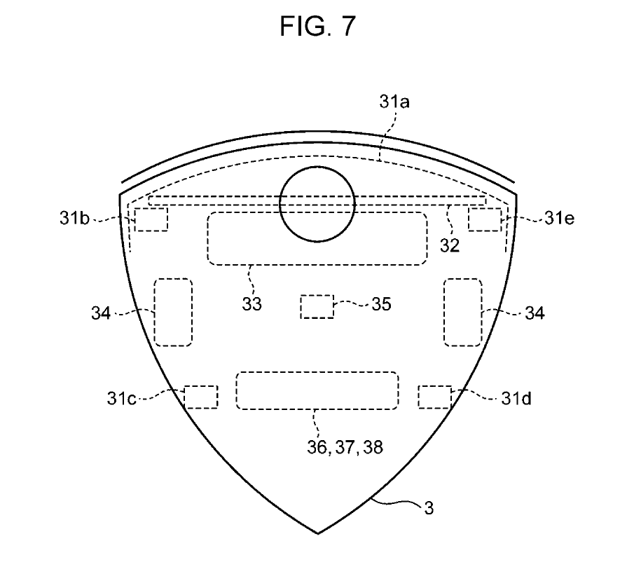

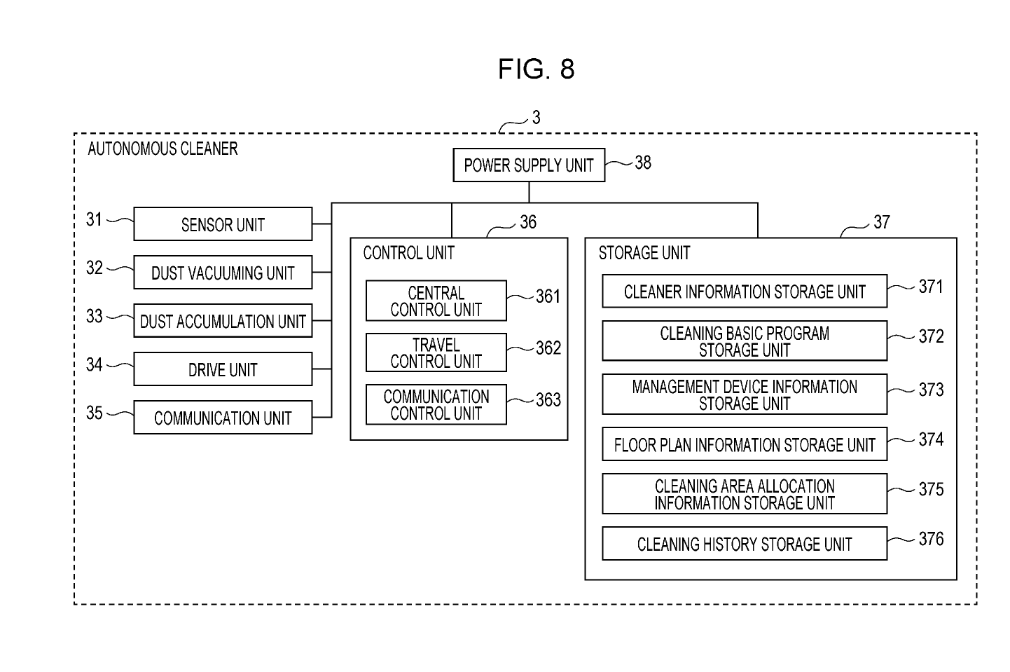

FIG. 7 is an external transparent view of the autonomous cleaner 3 according to the first embodiment as viewed from above. FIG. 8 is a block diagram illustrating the functional configuration of the autonomous cleaner 3 according to the first embodiment. The autonomous cleaner 3 includes a sensor unit 31, a dust vacuuming unit 32, a dust accumulation unit 33, a drive unit 34, a communication unit 35, a control unit 36, a storage unit 37, and a power supply unit 38.

The sensor unit 31 is a sensor to sense the situation around the autonomous cleaner 3 and/or the state of the autonomous cleaner 3. The sensor unit 31 includes an obstacle sensor that emits infrared rays or ultrasonic waves for example, and measures the infrared rays or ultrasonic waves reflected back from obstacles, thereby detecting distances to obstacles, a contact sensor that detects obstacles by coming into contact with objects in a case where the obstacle sensor is not able to judge obstacles, a gyro sensor that measures the angle of the body of the autonomous cleaner 3, a travel sensor that measures the distance that the autonomous cleaner 3 has traveled, and so forth. FIG. 7 illustrates an example where the sensor unit 31 has a contact sensor 31a that is one type of sensor, and obstacle sensors 31b through 31e.

The dust vacuuming unit 32 is configured including a motor, fan, filter, and exhaust vent, for example (all omitted from illustration). When the motor rotates the fan, dust is suctioned along with air, just the air passes through the filter, and the air alone that has passed through is blown out from the exhaust vent. Dust that has been suctioned by the dust vacuuming unit 32 is accumulated in the dust accumulation unit 33.

The drive unit 34 moves the autonomous cleaner 3. The drive unit 34 is configured of a motor and wheels, for example (all omitted from illustration), and causes the autonomous cleaner 3 to travel by controlling the rotation of the motor and rotating the wheels.

The communication unit 35 transmits and receives information to and from external devices such as the management device 2, via a LAN or WAN. The communication unit 35 receives cleaning instruction information instructing cleaning of cleanable areas, and transmits position information of the autonomous cleaner 3 to the management device 2, for example. The communication unit 35 may periodically transmit position information of the autonomous cleaner 3 to the management device 2, or may transmit upon request from the management device 2.

The control unit 36 is a CPU for example, and controls the operations of the autonomous cleaner 3. The control unit 36 includes a central control unit 361, a travel control unit 362, and a communication control unit 363.

The storage unit 37 is semiconductor memory for example, and includes a cleaner information storage unit 371, a cleaning basic program storage unit 372, a management device information storage unit 373, a floor plan information storage unit 374, a cleaning area allocation information storage unit 375, and a cleaning history storage unit 376.

The central control unit 361 controls the components of the autonomous cleaner 3. The communication control unit 363 controls the communication unit 35, and transmits and receives various types of information via the communication unit 35.

The cleaner information storage unit 371 stores information relating to the autonomous cleaner 3. Examples of information relating to the autonomous cleaner 3 include identification information for identifying the autonomous cleaner 3 and communication address information of the autonomous cleaner 3. The identification information and communication address information may be stored beforehand at the time of manufacturing, or may be set by the user.

The cleaning basic program storage unit 372 stores a cleaning basic program to cause the autonomous cleaner 3 to travel, based on predetermined movement patterns. The cleaning basic program is stored beforehand, at the time of manufacturing. When cleaning a cleaning area instructed by the management device 2, the travel control unit 362 selects one of predetermined movement patterns based on the cleaning basic program stored in the cleaning basic program storage unit 372, and controls the drive unit 34 to cause the autonomous cleaner 3 to travel and perform cleaning. Examples of movement patterns include wall-following traveling where the travels following an obstacle such as a wall or the like, zig-zag travelling where the autonomous cleaner 3 travels in a zig-zag pattern, random travelling where the autonomous cleaner 3 travels randomly, spiral traveling where the autonomous cleaner 3 travels in a spiral, for example. The travel control unit 362 performs cleaning by traveling while changing movement patterns in accordance with the situation around the autonomous cleaner 3 and the state of the autonomous cleaner 3. The autonomous cleaner 3 may have a configuration to access a server or the like of the manufacturer of the autonomous cleaner 3 and acquire an update program for the cleaning basic program, thereby updating movement patterns.

The management device information storage unit 373 stores information relating to the management device 2. Information relating to the management device 2 includes identification information for identifying the management device 2 and communication address information of the management device 2, for example. Information relating to the management device 2 may be stored beforehand at the time of manufacturing, or may be set by the user.

The floor plan information storage unit 374 stores floor plan information indicating the floor plan of the space to be cleaned. The floor plan information is obtained from the management device 2, for example. As another method for obtaining floor plan information, in a case where the autonomous cleaner 3 has a map creating function, the autonomous cleaner 3 may store map information created by itself as floor plan information. Note that the floor plan information is used to identify cleaning areas to be cleaning in accordance with cleaning instruction information from the management device 2, so the floor plan information stored in the management device 2 and autonomous cleaner 3 preferably is the same.

The cleaning area allocation information storage unit 375 stores information indicating a cleaning area specified in cleaning instruction information received from the management device 2. The autonomous cleaner 3 travels to the cleaning area to be cleaned, based on this information, and performs cleaning.

The cleaning history storage unit 376 stores cleaning history information of having cleaned the cleaning area specified by the cleaning instruction information received from the management device 2. The cleaning history information includes information such as the time of day that the autonomous cleaner 3 started cleaning, the time of day that the autonomous cleaner 3 completed cleaning, progress information indicating the state of progress of cleaning by the autonomous cleaner 3. The cleaning history information is stored in the management device 2 in the same way, but also is stored in the autonomous cleaner 3. That is to say, if the autonomous cleaner 3 travels to a place where communication signals are not good while cleaning, the cleaning history information at that point cannot be transmitted to the management device 2, so the autonomous cleaner 3 stores the cleaning history information. Accordingly, when communication signals are stronger, the autonomous cleaner 3 can transmit the stored cleaning history information to the management device 2.

The power supply unit 38 is a battery that supplies electric power to the components of the autonomous cleaner 3.

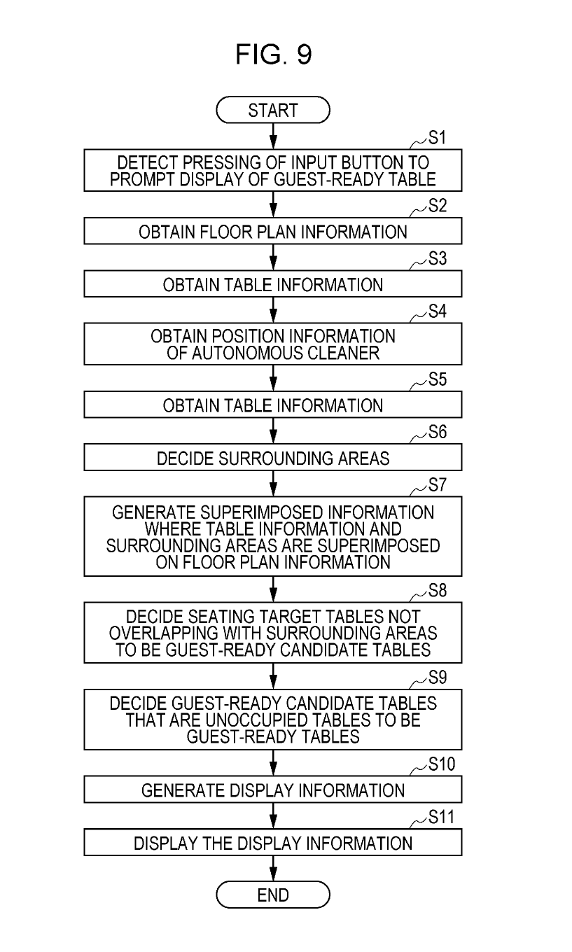

Next, a method according to the first embodiment of displaying, on the terminal device 1 that the employee 4 carries, guest-ready tables to which a guest 5 can be shown, in a case of the guest 5 arriving in the midst of the autonomous cleaner 3 cleaning the eatery 10, will be described in detail with reference to the flowchart in FIG. 9. FIG. 9 is a flowchart for describing the processing at the terminal device 1 in the first embodiment. The terminal device 1 displays guest-ready tables in a case of a guest arriving.

As a prerequisite, a guest-ready table display application (omitted from illustration) is installed in the terminal device 1 beforehand, and the following processing is performed at the guest-ready table display application. The description below will be made assuming that the guest-ready table display application in the terminal device 1 has already been activated by the user. Once the guest-ready table display application is activated, the display unit 12 of the terminal device 1 displays an input button prompting display of guest-ready tables, and when the employee 4 presses this displayed input button, processing to display guest-ready tables is started. The input unit 13 is configured with a touchscreen that is integrated with the display unit 12.

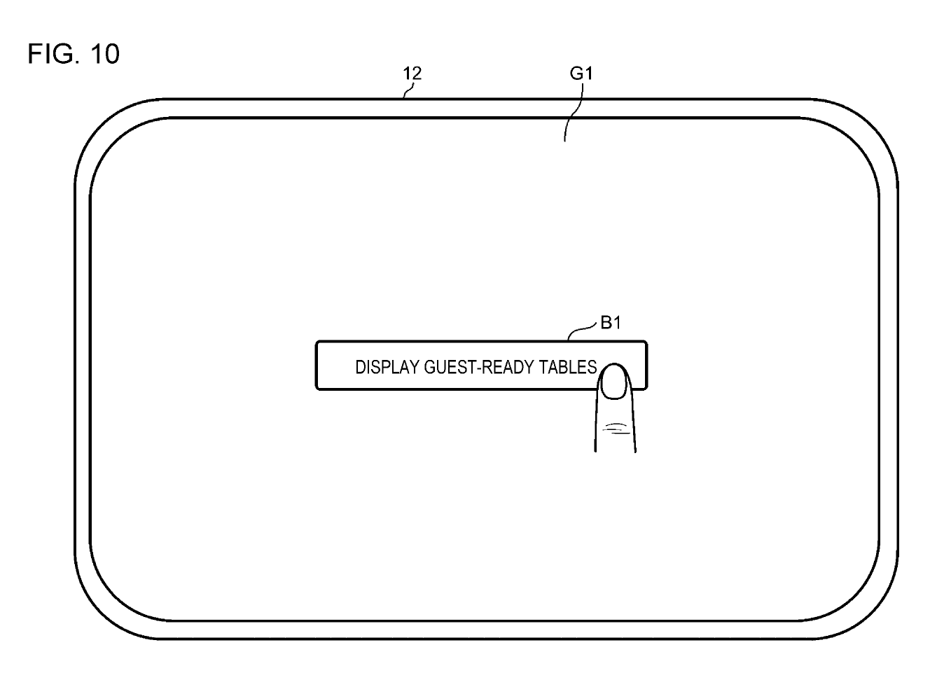

First, the input detection unit 144 detects that the employee 4 has pressed the input button prompting display of guest-ready tables, displayed on the display unit 12 (step S1). FIG. 10 illustrates an example of a display screen including the input button to prompt display of guest-ready tables. The display unit 12 displays the display screen G1 including the input button B1. The employee 4 presses (touches) the input button B1 with a finger, thereby prompting display of guest-ready tables.

Next, the communication control unit 142 transmits request information to the management device 2 via the communication unit 11, requesting transmission of floor plan information, and obtains the floor plan information from the management device 2 (step S2). The communication control unit 142 stores the obtained floor plan information in the floor plan information storage unit 151 of the storage unit 15.

The communication control unit 142 then transmits request information to the management device 2 via the communication unit 11, requesting transmission of table information, and obtains table information from the management device 2 (step S3). The communication control unit 142 stores the obtained table information in the table information storage unit 152 of the storage unit 15.

The communication control unit 142 then transmits request information to the management device 2 via the communication unit 11, requesting transmission of position information of the autonomous cleaner 3, and obtains the position information of the autonomous cleaner 3 from the management device 2 (step S4). The communication control unit 142 stores the obtained position information of the autonomous cleaner 3 in the position information storage unit 153 of the storage unit 15.

Now, the position information of the autonomous cleaner 3 preferably is position information of the autonomous cleaner 3 at a time close to the current time of day. Accordingly, when transmission of the position information of the autonomous cleaner 3 is requested to the management device 2 by the terminal device 1, the management device 2 preferably obtains the current position information of the autonomous cleaner 3 from the autonomous cleaner 3 in response to the request from the terminal device 1, and transmits the obtained current position information of the autonomous cleaner 3 to the terminal device 1.

Next, the communication control unit 142 transmits request information to the management device 2 via the communication unit 11, requesting transmission of unoccupied table information, and obtains unoccupied table information from the management device 2 (step S5). The communication control unit 142 stores the obtained unoccupied table information in the unoccupied table information storage unit 155 of the storage unit 15. Now, the unoccupied table information preferably is unoccupied table information at a time close to the current time of day. Accordingly, when transmission of unoccupied table information is requested to the management device 2 by the terminal device 1, the management device 2 preferably judges whether or not each table is an unoccupied table at the current time or day and generates unoccupied table information, and transmits the generated unoccupied table information to the terminal device 1.

The guest-ready table deciding unit 146 then decides a surrounding area around the autonomous cleaner 3, based on the floor plan information and position information of the autonomous cleaner 3 received from the management device 2, and surrounding area information stored in the surrounding area information storage unit 154 (step S6).

The guest-ready table deciding unit 146 then generates superimposed information where the table information and surrounding area have been superimposed on the floor plan information, based on the floor plan information, table information, and position information of the autonomous cleaner 3, received from the management device 2, and the decided surrounding area (step S7).

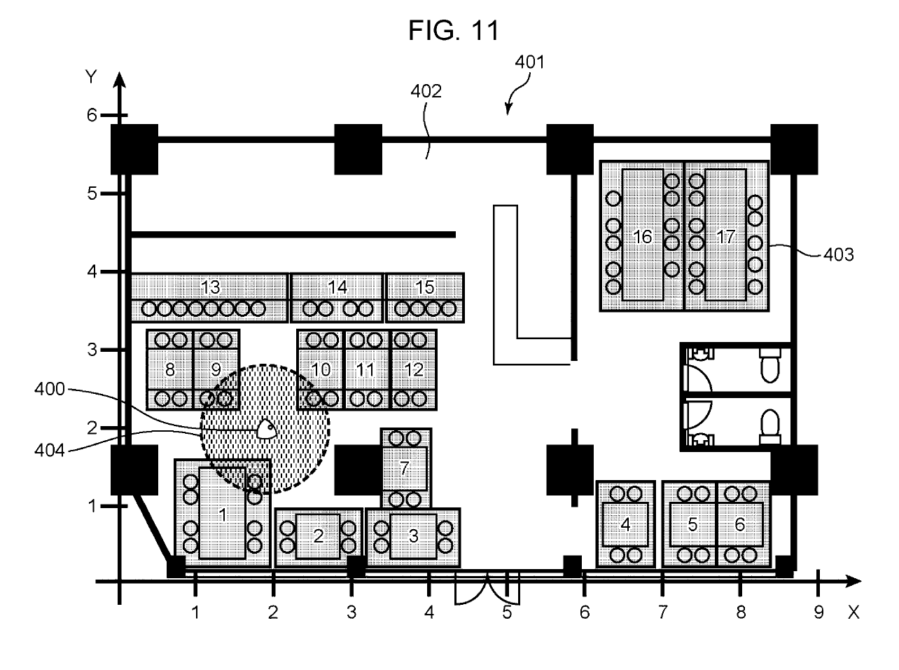

FIG. 11 is a diagram illustrating an example of superimposed information where the table information and surrounding area have been superimposed on the floor plan information in the first embodiment. The superimposed information 401 illustrated in FIG. 11 shows multiple seating target tables 403 and a surrounding area 404 superimposed on a floor plan 402. In the superimposed information 401 illustrated in FIG. 11, a position 400 of the autonomous cleaner 3 is also superimposed on the floor plan 402.

Next, the guest-ready table deciding unit 146 decides, out of the multiple seating target tables, seating target tables that do not overlap the surrounding area to be guest-ready candidate tables, based on the generated superimposed information (step S8). In the example illustrated in FIG. 11, the seating target tables 403 corresponding to table identification Nos. “1”, “9”, and “10” overlap the surrounding area 404, so the seating target tables 403 corresponding to table identification Nos. “2” through “8” and “11” through “17” are decided to be guest-ready candidate tables.

The guest-ready table deciding unit 146 then decides, out of the decided guest-ready candidate tables, guest-ready candidate tables that are unoccupied tables to be guest-ready tables, based on the unoccupied table information received from the management device 2 (step S9).

Next, the display information generating unit 145 generates display information to display the guest-ready tables decided by the guest-ready table deciding unit 146 on the display unit 12 (step S10).

The display control unit 143 then displays the generated display information on the display unit 12 (step S11).

Now, the display control unit 143 may also display not-guest-ready tables to which guests cannot be show, besides displaying guest-ready tables. In the case of this configuration, the guest-ready table deciding unit 146 decides that of the multiple seating target tables (seating target areas), the seating target tables (seating target areas) other than guest-ready tables (guest-ready areas) are decided to be not-guest-ready tables (not-guest-ready areas). The display control unit 143 displays the guest-ready tables and not-guest-ready tables using different forms. According to this configuration, the user (employee) can decide tables to show guests to, with comprehension of the state of tables throughout the building.

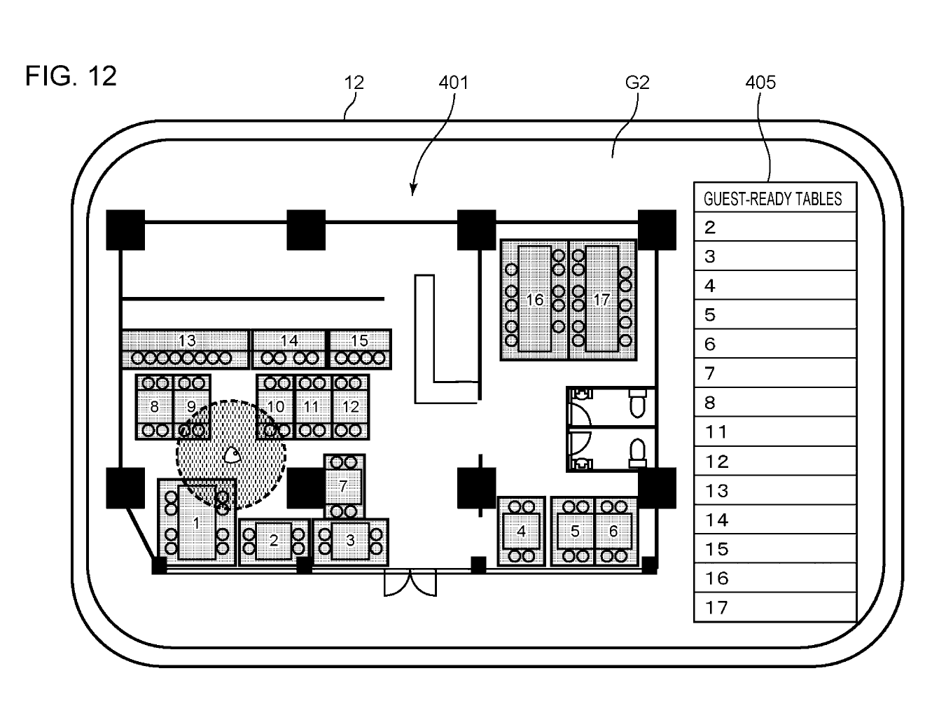

FIG. 12 is a diagram illustrating an example of a display screen displaying guest-ready tables in the first embodiment. A display screen G2 illustrated in FIG. 12 includes a guest-ready table list 405 where a list has been compiled of guest-ready tables. The guest-ready table list 405 includes table identification Nos. indicating guest-ready tables. The display screen G2 displays the superimposed information 401, where the position of the autonomous cleaner 3, table information, and surrounding area, are superimposed on the floor plan information along with the guest-ready tables. Displaying the superimposed information 401 along with the guest-ready tables enables the user (employee) to comprehend the current position of the autonomous cleaner 3 and not-guest-ready tables as well.

In a case where multiple guest-ready tables exist, such as illustrated in FIG. 12, an arrangement may be made where a degree of priority is given to each of the multiple guest-ready tables, and the multiple guest-ready tables are displayed in accordance with the degree of priority. In the case of this configuration, degree-of-priority imparting conditions to impart the degree of priority are necessary. These degree-of-priority imparting conditions may be obtained from the management device 2, or may be generated by the user at the terminal device 1.

For example, in a case where multiple guest-ready tables (guest-ready areas) have been decided as guest-ready tables (guest-ready areas), the communication control unit 142 obtains degree-of-priority imparting condition information indicating conditions for imparting degree of priority of multiple guest-ready tables (guest-ready areas) to each of the multiple guest-ready tables (guest-ready areas) via the communication unit 11. Then in a case where multiple guest-ready tables (guest-ready areas) have been decided, the guest-ready table deciding unit 146 imparts degree of priority to each of the multiple guest-ready tables (guest-ready areas), based on the degree-of-priority imparting condition information.

The display control unit 143 displays the multiple guest-ready tables (guest-ready areas) using different forms, based on the degree of priority. More specifically, the display control unit 143 displays the multiple guest-ready tables (guest-ready areas) in descending order of the degree of priority.

As a method to display guest-ready tables according to degrees of priority, a high degree of priority may be imparted to guest-ready tables in the order of being farthest away from the current position of the autonomous cleaner 3. That is to say, the degree-of-priority imparting condition information may include a condition of imparting a higher degree of priority in order from the guest-ready tables (guest-ready areas) farthest away from the current position of the autonomous cleaner 3. According to this configuration, guest-ready tables are displayed in order of those farthest away from the autonomous cleaner 3, so the user (employee) can show guests to tables in the order of being less affected by flying dust and noise due to the autonomous cleaner 3 cleaning. The distance from the current position of the autonomous cleaner 3 to the guest-ready table may be the distance from a representative point at the center of the dining table at the guest-ready table to the current position of the autonomous cleaner 3. The representative point at the guest-ready table may be any point.

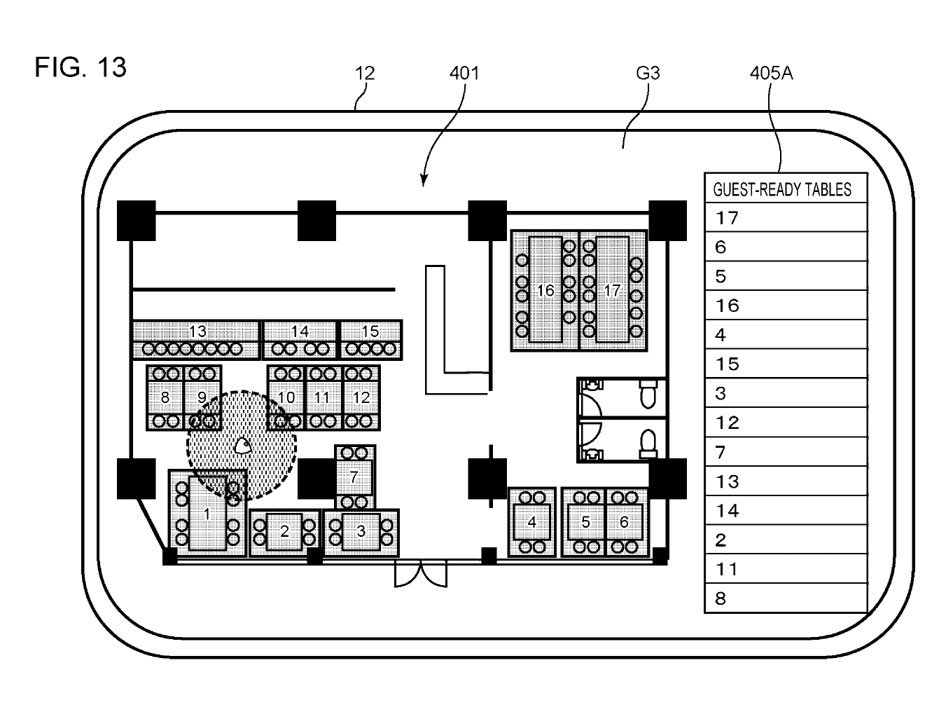

FIG. 13 is a diagram illustrating an example of a display screen that displays the guest-ready tables in order from the farthest from the current position of the autonomous cleaner 3 in the first embodiment. The same guest-ready tables have been decided in FIG. 13 as those in FIG. 12. The display screen G3 illustrated in FIG. 13 includes a guest-ready table list 405A where a list has been compiled of guest-ready tables. The guest-ready table list 405 displays the guest-ready tables in descending order of the degree of priority, with the guest-ready tables the farthest from the current position of the autonomous cleaner 3 being imparted the highest degree of priority in order.

As another method of displaying guest-ready tables with degree of priority imparted, guest-ready tables regarding which the time of day of the autonomous cleaner 3 having completed cleaning is the most recent may be imparted the highest degree of priority in order, for example. That is to say, the degree-of-priority imparting condition information may include a condition of imparting a higher degree of priority in order from the guest-ready tables (guest-ready areas) regarding which the time of day of the autonomous cleaner 3 having completed cleaning is the most recent. According to this configuration, guest-ready tables are displayed in order of those regarding which the least amount of time has elapsed from having been cleaned by the autonomous cleaner 3, so the user (employee) can show guests to guest-ready tables in the order of those where there conceivable is less dust accumulated.

As another method of displaying guest-ready tables with degree of priority imparted, guest-ready tables satisfying predetermined conditions may be imparted the highest degree of priority in order. For example, in a case where rules have been decided beforehand in the eatery regarding showing guests to their tables, the priority of guest-ready tables satisfying these rules is set high. According to this configuration, the user can set rules beforehand, and the terminal device 1 can display guest-ready tables in accordance with the rules.

Conceivable examples of rules decided in the eatery beforehand may include setting the priority high for guest-ready tables where adjacent tables are unoccupied. People have a certain space that they feel uncomfortable when others enter into, called “personal space”. Guests will often prefer a table where there is nobody at adjacent tables, over a table where there are other guests at adjacent tables. Accordingly, the user (employee) can show guests to tables taking personal space into consideration.

Another conceivable example of rules decided in the eatery beforehand may include setting the priority high for window-side guest-ready tables. Some eateries may boast the scenery viewable from the windows, and in such eateries, it is desirable to show guests to window-side guest-ready tables with priority. According to this configuration, the terminal device 1 can display window-side guest-ready tables with priority.

The method of displaying guest-ready tables imparted with a degree of priority may combine the above-exemplified multiple methods. For example, the guest-ready tables may be imparted with degrees of priority in the respective methods of imparting degree of priority, and further each degree of priority may be given a score, so that the scores given to the guest-ready tables can be added up and guest-ready tables be displayed in order from the highest score. According to this configuration, the terminal device 1 can display guest-ready tables, which are judged to have a high overall degree of priority from various perspectives, with priority.

Further, an arrangement may be made where the user selecting one of the above-exemplified methods for the degree of priority to be imparted, so the user can impart priority in accordance as needed. According to this configuration, degrees of priority can be imparted to guest-ready tables in accordance with the needs of individual eateries, giving greater freedom in methods to impart the degree of priority.

As the method of displaying guest-ready tables with degree of priority imparted, an arrangement may be made where only a predetermined number of guest-ready tables with high degree of priority are displayed. According to this configuration, guest-ready tables with a low degree of priority are not displayed, and guest-ready tables with a high degree of priority are displayed in a limited manner, so the employee will find it easier to select guest-ready tables. Now, demand will differ from user to user regarding the number of guest-ready tables to display, so the number of guest-ready tables to display preferably is settable by the user.

According to the above processing, in a case where a guest arrives while the autonomous cleaner 3 is cleaning, seating target tables that are unoccupied and not in the surrounding area around the autonomous cleaner 3, can be displayed on the terminal device 1 that the employee carries, out of the multiple seating target tables.

Note that while a configuration has been described in the first embodiment where the guest-ready tables are displayed in a list format, the present disclosure is not restricted to this configuration. For example, the guest-ready tables and not-guest-ready tables superimposed on the floor plan information may be displayed using different forms. Specific examples that can be conceived include different display forms such as colors, color densities, patterns, and so forth, that differ from each other.

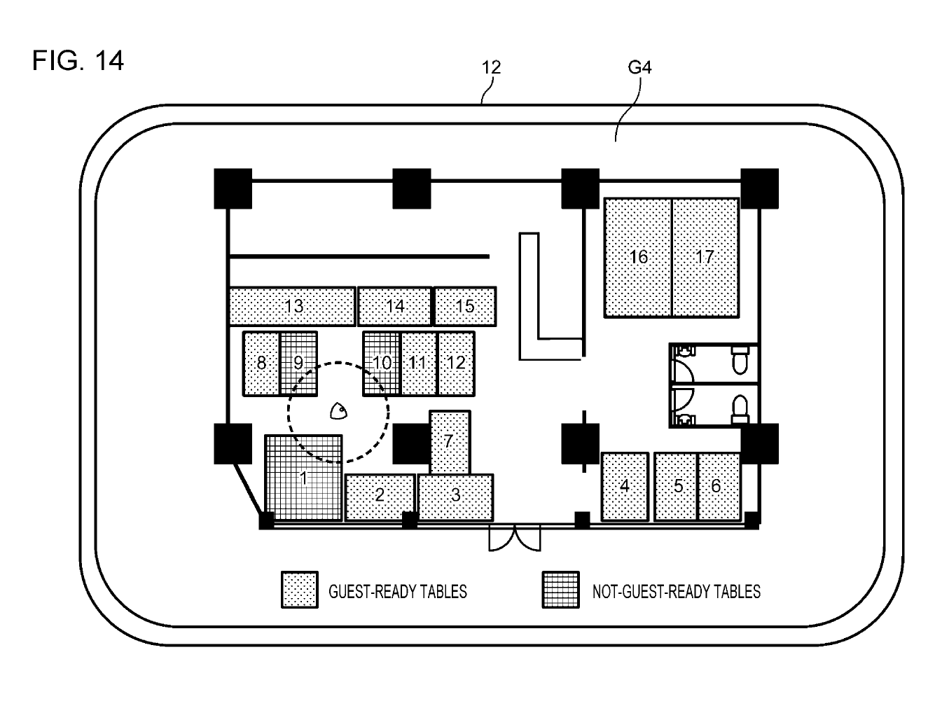

FIG. 14 is a diagram illustrating an example of a display screen where the display forms of guest-ready tables and not-guest-ready tables have been differentiated from each other in the first embodiment. In display screen G4 illustrated in FIG. 14, the guest-ready tables are represented by dot patterns, and the not-guest-ready tables are represented by grid patterns. According to this configuration, the user can easily distinguish between guest-ready tables and not-guest-ready tables.

Also, in a case of displaying guest-ready tables with imparted, the display forms of the guest-ready tables may be changed in accordance with the degree of priority. Specific examples that can be conceived include different display forms such as colors, color densities, patterns, and so forth, that differ from each other, in accordance with the level of priority. According to this configuration, the user can visually comprehend the degree of priority.

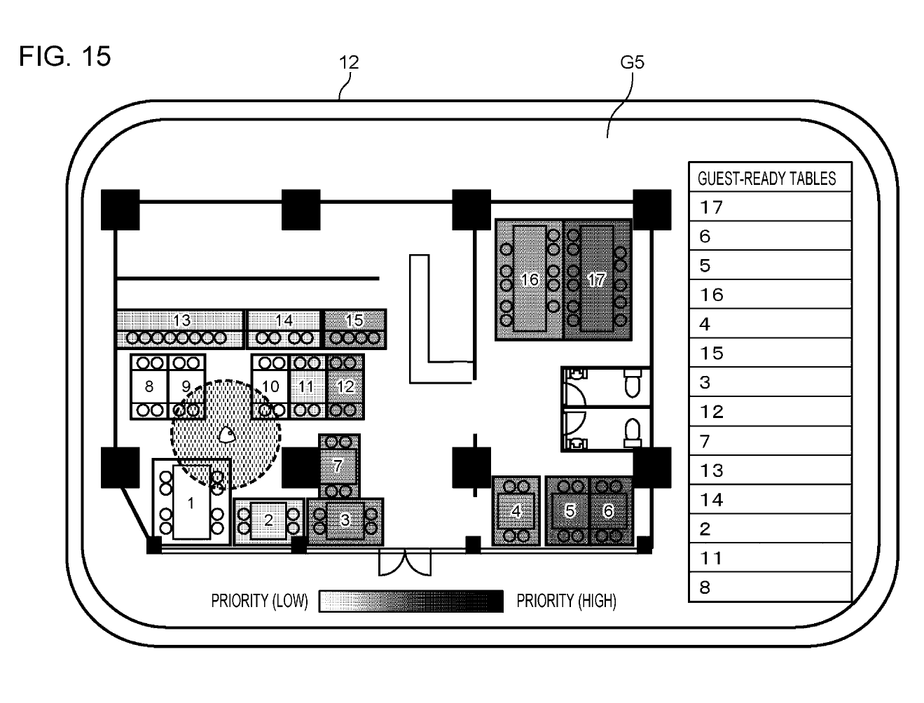

FIG. 15 is a diagram illustrating an example of a display screen where the display forms of guest-ready tables have been differentiated by degree of priority in the first embodiment. Note that the guest-ready tables in FIG. 15 have been imparted the same degree of priority as the example in FIG. 13. In display screen G5 illustrated in FIG. 15, the density of the color (gray) of guest-ready tables is changed in accordance with the level of priority. For example, the density of guest-ready tables of which the degree of priority is high is dark, and the density of guest-ready tables of which the degree of priority is low is light. In this way, the display control unit 143 may display guest-ready tables (guest-ready areas) with different degrees of priority using different forms. The display control unit 143 may also display multiple guest-ready tables (guest-ready areas) en bloc with the display forms different for each degree of priority.

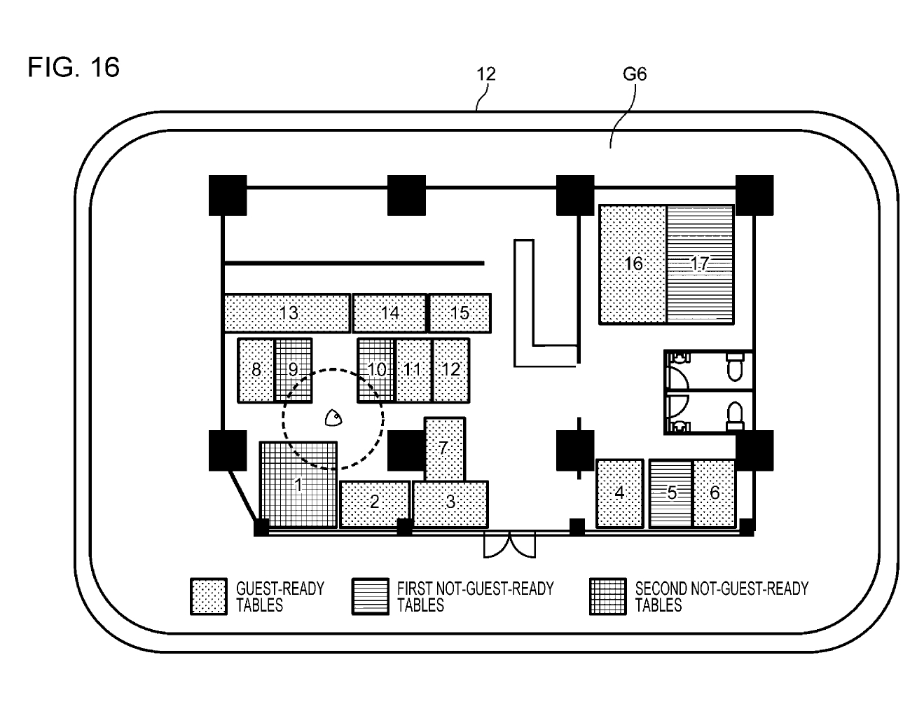

Also, a configuration may be made where, of the not-guest-ready tables, tables that are not-guest-ready tables due to not being unoccupied, and tables that are, despite being unoccupied tables, not-guest-ready tables due to overlapping the surrounding area of the autonomous cleaner 3, may be displayed with different forms. FIG. 16 is a diagram illustrating an example of a display screen displaying first not-guest-ready tables that are not-guest-ready tables due to not being unoccupied, and second not-guest-ready tables that are unoccupied but are not-guest-ready tables due to overlapping the surrounding area of the autonomous cleaner 3, using different forms in the first embodiment. In display screen G6 illustrated in FIG. 16, guest-ready tables are represented by a dot pattern, first not-guest-ready tables that are not guest-ready due to being occupied are represented by a stripe pattern, and second not-guest-ready tables that are not guest-ready due to overlapping the surrounding area of the autonomous cleaner 3 are represented by a grid pattern.

The not-guest-ready tables are all seating target tables excluding guest-ready tables. Of these not-guest-ready tables, the guest-ready table deciding unit 146 decides seating target tables that are occupied based on person-presence information, to be first not-guest-ready tables (first not-guest-ready areas). Of the not-guest-ready tables, the guest-ready table deciding unit 146 decides seating target tables that are not guest-ready due to overlapping the surrounding area of the autonomous cleaner 3 to be second not-guest-ready tables (second not-guest-ready areas). The display control unit 143 displays the first not-guest-ready tables (first not-guest-ready areas) and second not-guest-ready tables (second not-guest-ready areas) using different forms.

According to this configuration, the user can distinguish between first not-guest-ready tables that are not guest-ready due to no being unoccupied, and second not-guest-ready tables that are unoccupied but are not guest-ready due to overlapping the surrounding area of the autonomous cleaner 3, and thus can comprehend which tables are the second not-guest-ready tables that can be changed to guest-ready tables by stopping the autonomous cleaner 3. In this way, second not-guest-ready tables that are unoccupied but are not guest-ready due to overlapping the surrounding area of the autonomous cleaner 3 can be changed to guest-ready tables by stopping the autonomous cleaner 3.

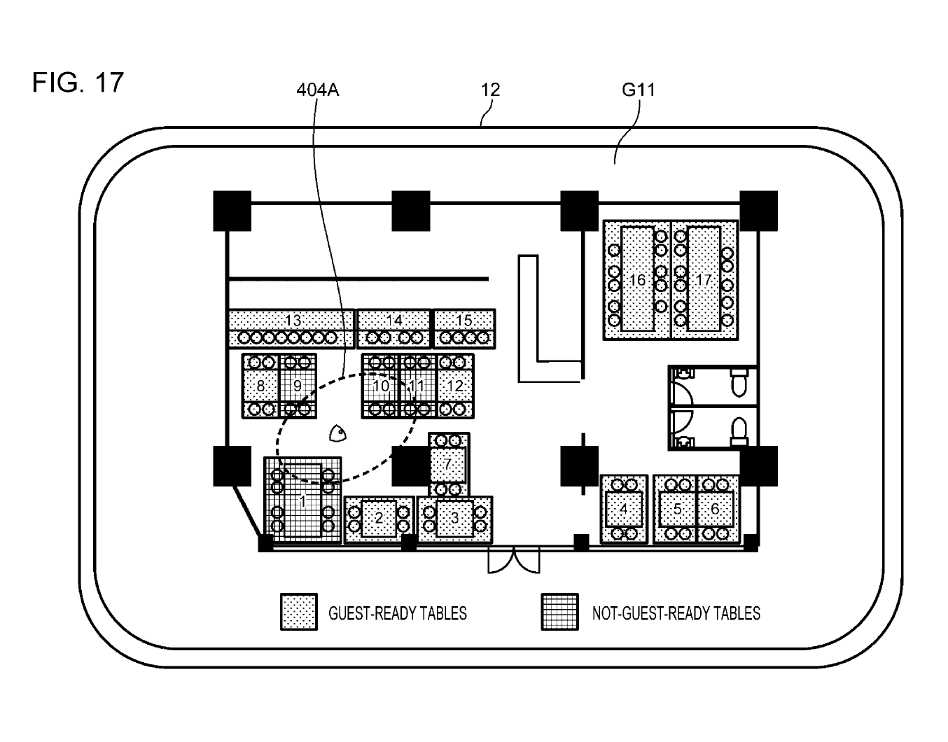

Note that while the surrounding area is circular in the first embodiment, but the present disclosure is not particularly restricted to this. The surrounding area may be another shape in accordance with the direction of travel of the autonomous cleaner 3. FIG. 17 is a diagram illustrating an example of a display screen where a surrounding area decided in accordance with the direction of travel of the autonomous cleaner 3 has been superimposed on the floor plan information in the first embodiment.

In a case where the direction of travel of the autonomous cleaner 3 is decided, the guest-ready table deciding unit 146 may decide the surrounding area around the autonomous cleaner 3 based on the floor plan information received from the management device 2, the position information of the autonomous cleaner 3, information indicating the direction of travel of the autonomous cleaner 3, and surrounding area information stored in the surrounding area information storage unit 154. The information indicating the direction of travel of the autonomous cleaner 3 is received from the management device 2.

In display screen G11 illustrated in FIG. 17, the direction of travel of the autonomous cleaner 3 is toward the upper right direction in the display screen G11, and the surrounding area 404A is broader from the current position toward the direction of travel, forming an oval. The guest-ready tables and not-guest-ready tables are displayed using different forms from each other in FIG. 17, with the guest-ready tables represented by a dot pattern and the not-guest-ready tables represented by a grid pattern. Thus, in a case where the direction of travel of the autonomous cleaner 3 is decided, the surrounding area 404A is broadened in the direction of travel of the autonomous cleaner 3. Accordingly, the user can recognize the direction of travel of the autonomous cleaner 3, which can prevent the user from showing guests to a place where the autonomous cleaner 3 is going to travel to.

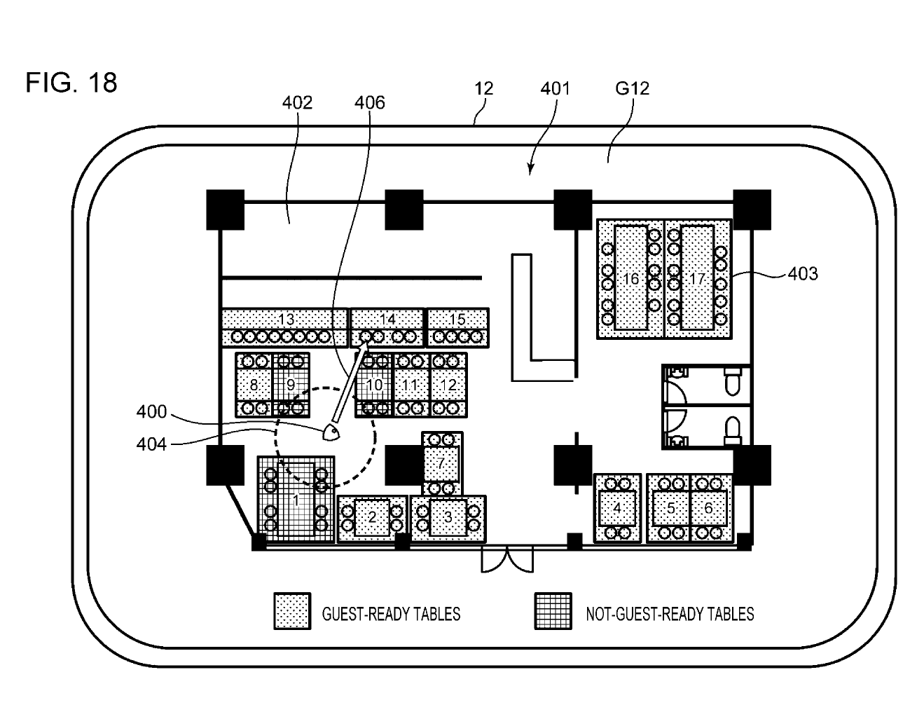

Also, in a case where the direction of travel of the autonomous cleaner 3 is decided in the first embodiment, the display unit 12 may display the travel route of the autonomous cleaner 3 in addition to the superimposed information and guest-ready areas. FIG. 18 is a diagram illustrating an example of a display screen where the travel route of the autonomous cleaner 3 has been superimposed on the floor plan information in the first embodiment.

In a case where the direction of travel of the autonomous cleaner 3 is decided, the guest-ready table deciding unit 146 may generate superimposed information where the table information, surrounding area, and travel route of the autonomous cleaner 3, are superimposed on the floor plan information, based on the floor plan information received from the management device 2, table information, the position information of the autonomous cleaner 3, surrounding area, and information indicating the direction of travel of the autonomous cleaner 3. The information indicating the direction of travel of the autonomous cleaner 3 is received from the management device 2.

In display screen G12 illustrated in FIG. 18, superimposed information 401 has multiple seating target tables 403, the surrounding area 404, and the travel route 406 of the autonomous cleaner 3, superimposed on the floor plan 402. The travel route 406 of the autonomous cleaner 3 is represented by the direction of a vector. In a case where the travel speed of the autonomous cleaner 3 is decided, the guest-ready table deciding unit 146 may change the length of the vector in accordance with the travel speed of the autonomous cleaner 3. Also, the guest-ready tables and not-guest-ready tables are displayed using different forms from each other in FIG. 18, with the guest-ready tables represented by a dot pattern and the not-guest-ready tables represented by a grid pattern. Thus, in a case where the travel route of the autonomous cleaner 3 is decided, the travel route of the autonomous cleaner 3 is displayed in addition to guest-ready areas, so the user can show guests to their table while avoiding the travel route of the autonomous cleaner 3.

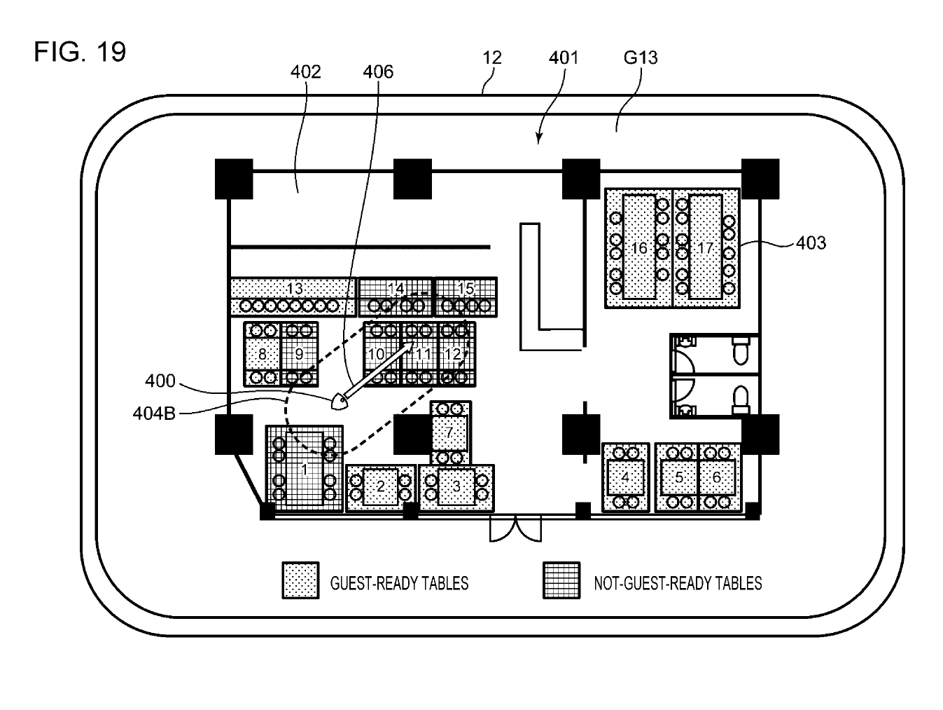

Also, in a case where the travel route of the autonomous cleaner 3 is decided in the first embodiment, the surrounding area may have another shape in accordance with the travel route of the autonomous cleaner 3. FIG. 19 is a diagram illustrating an example of a display screen where the surrounding area decided in accordance with the travel route of the autonomous cleaner 3 has been superimposed on the floor plan information in the first embodiment.

In a case where the travel route of the autonomous cleaner 3 is decided, the guest-ready table deciding unit 146 may decide the surrounding area around the autonomous cleaner 3 based on the floor plan information received from the management device 2, the position information of the autonomous cleaner 3, information indicating the travel route of the autonomous cleaner 3, and surrounding area information stored in the surrounding area information storage unit 154. The information indicating the travel route of the autonomous cleaner 3 is received from the management device 2.

In display screen G13 illustrated in FIG. 19, the superimposed information 401 has multiple seating target tables 403, the surrounding area 404B, and the travel route 406 of the autonomous cleaner 3, superimposed on the floor plan 402. The travel route 406 of the autonomous cleaner 3 is represented by the direction of a vector. In a case where the travel speed of the autonomous cleaner 3 is decided, the guest-ready table deciding unit 146 may change the length of the vector in accordance with the travel speed of the autonomous cleaner 3.

The surrounding area 404B has a shape representing the path that will be traveled by the circular surrounding area centered on the position of the autonomous cleaner 3, from the current position to the position of the autonomous cleaner 3 at a predetermined amount of time later. Also, the guest-ready tables and not-guest-ready tables are displayed using different forms from each other in FIG. 19, with the guest-ready tables represented by a dot pattern and the not-guest-ready tables represented by a grid pattern. Thus, in a case where the travel route of the autonomous cleaner 3 is decided, the surrounding area 404B is expanded following the path of the travel route of the autonomous cleaner 3, so the user can show guests to their table while avoiding the range of travel of the autonomous cleaner 3.

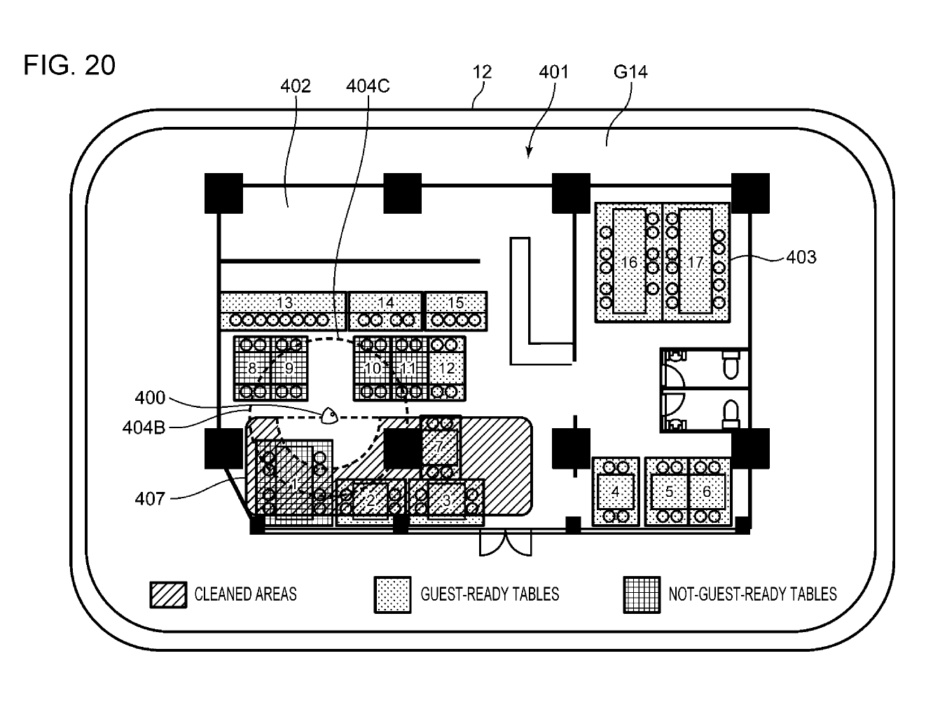

Also, an arrangement may be made in the first embodiment where information representing cleaned areas, where the autonomous cleaner 3 has already completed cleaning, is obtained, and the display unit 12 displays the cleaned areas of the autonomous cleaner 3 in addition to the superimposed information and guest-ready areas. FIG. 20 is a diagram illustrating an example of a display screen where cleaned areas of the autonomous cleaner 3 are superimposed on the floor plan information in the first embodiment.

The guest-ready table deciding unit 146 may generate superimposed information where the table information, the surrounding area, and cleaned areas of the autonomous cleaner 3, are superimposed on the floor plan information, based on the floor plan information received from the management device 2, table information, the position information of the autonomous cleaner 3, the surrounding area, and information indicating the cleaned areas of the autonomous cleaner 3. The information indicating the cleaned areas of the autonomous cleaner 3 is received from the management device 2.

In display screen G14 illustrated in FIG. 20, the superimposed information 401 has multiple seating target tables 403, the surrounding area 404C, and the cleaned area 407 of the autonomous cleaner 3, superimposed on the floor plan 402. The surrounding area 404C is decided such that the size of the portion thereof not overlapping the cleaned area 407 is larger than the size of the portion thereof overlapping the cleaned area 407. Also, the guest-ready tables and not-guest-ready tables are displayed using different forms from each other in FIG. 20, with the guest-ready tables represented by a dot pattern and the not-guest-ready tables represented by a grid pattern. The display unit 12 does not have to display the cleaned area 407. In this way, the surrounding area 404C is decided such that the size of the portion thereof not overlapping the cleaned area 407 is larger than the size of the portion thereof overlapping the cleaned area 407, so the user can estimate the location to which the autonomous cleaner 3 will move next, and can show guests to their table while avoiding the destination of travel of the autonomous cleaner 3.

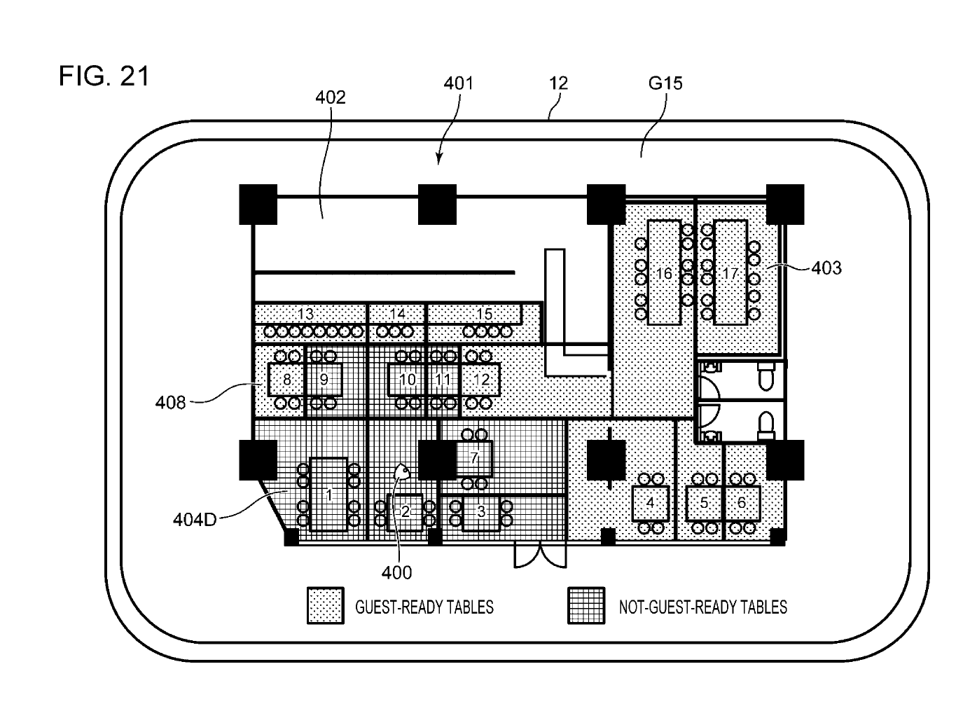

In a case where the predetermined space has been divided into areas that the autonomous cleaner 3 individually cleans, and multiple cleaning target areas obtained thereby are set beforehand, a cleaning target area out of the multiple cleaning target areas where the autonomous cleaner 3 currently is may be decided to be a currently-cleaning area, and cleaning target areas around the currently-cleaning area out of the multiple cleaning target areas may be decided to be a surrounding area. FIG. 21 is a diagram illustrating an example of a display screen displaying guest-ready tables in a case where multiple cleaning target areas have been set beforehand in the first embodiment.

The guest-ready table deciding unit 146 may decide the surrounding area around the autonomous cleaner 3, based on the floor plan information received from the management device 2, position information of the autonomous cleaner 3, surrounding area information stored in the surrounding area information storage unit 154, and information indicating the cleaning target areas set in the floor plan information. The information indicating cleaning target areas indicates the positions of multiple cleaning target areas obtained by dividing the predetermined space into areas individually cleaned by the autonomous cleaner 3. The information indicating cleaning target areas is received from the management device 2.

In display screen G15 illustrated in FIG. 21, the superimposed information 401 has multiple seating target tables 403, the position 400 of the autonomous cleaner 3, the surrounding area 404D, and the multiple cleaning target areas 408, superimposed on the floor plan 402. The cleaning target area s are set beforehand, correlated with each of the tables in the eatery. Seventeen cleaning target areas are set in the floor plan of the eatery in FIG. 21, with the positions of the cleaning target areas being the same as the positions of the seating target table.

The guest-ready table deciding unit 146 decides the cleaning target area where the autonomous cleaner 3 is out of the multiple cleaning target areas to be the currently-cleaning area, and the cleaning target areas around the currently-cleaning area out of the multiple cleaning target areas as surrounding area 404D. The surrounding area information storage unit 154 may store surrounding area information indicating the surrounding area around each cleaning target area.

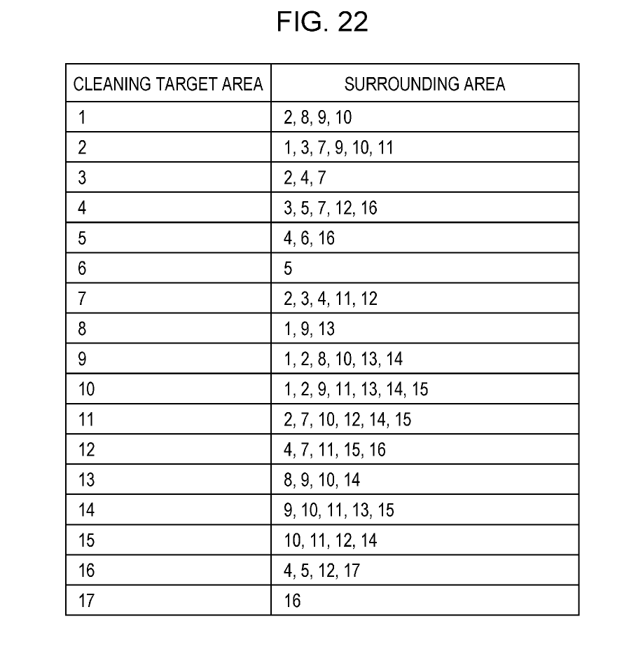

FIG. 22 is a diagram illustrating an example of surrounding area information stored in the surrounding area information storage unit 154, in a case where multiple cleaning target areas have been set beforehand in the first embodiment. The surrounding area information shown in FIG. 22 is generated based on a rule where a cleaning target area adjacent to a cleaning target area is a surrounding area. The surrounding area information storage unit 154 stores surrounding area information where each of the multiple cleaning target areas has been correlated with surrounding areas beforehand. The cleaning target areas adjacent to each cleaning target area are set as surrounding areas in FIG. 22. For example, cleaning target areas corresponding to table identification Nos. “2”, 8″, “9”, and “10” are correlated as surrounding areas with the cleaning target area corresponding to table identification No. “1”.

The guest-ready table deciding unit 146 decides surrounding areas corresponding the cleaning target area where the autonomous cleaner 3 is, based on the surrounding area information correlating each of the multiple cleaning target areas and the surrounding areas beforehand. In FIG. 21, the autonomous cleaner 3 is in the cleaning target area corresponding to table identification No. “2”, so the guest-ready table deciding unit 146 decides the cleaning target areas corresponding to the table identification Nos. “1”, “3”, “7”, “9”, “10”, and “11” to be surrounding areas.

The guest-ready table deciding unit 146 decides, of the multiple cleaning target areas, cleaning target areas excluding the cleaning target area where the autonomous cleaner 3 is and cleaning target areas corresponding to surrounding areas to be guest-ready candidate tables. The guest-ready table deciding unit 146 decides, of the guest-ready candidate tables, guest-ready candidate tables corresponding to seating target tables (cleaning target areas) where no person is present, to be guest-ready tables. Also, the guest-ready tables and not-guest-ready tables are displayed using different forms from each other in FIG. 21, with the guest-ready tables represented by a dot pattern and the not-guest-ready tables represented by a grid pattern.

Thus, multiple cleaning target areas obtained by dividing the predetermined space into areas that the autonomous cleaner 3 individually cleans are set beforehand, a cleaning target area out of the multiple cleaning target areas where the autonomous cleaner 3 currently is decided to be a currently-cleaning area, and cleaning target areas around the currently-cleaning area out of the multiple cleaning target areas are decided to be surrounding areas. Accordingly, the cleaning target area that the autonomous cleaner 3 will clean after the cleaning target area currently being cleaned can be predicted, and guests and be shown to their table while avoiding the travel destination of the autonomous cleaner 3.

Further, an arrangement may be made where the terminal device 1 obtains state information indicating the operating state of the autonomous cleaner 3, and out of the multiple seating target tables (seating target areas), decide seating target tables (seating target areas) that do not overlap the surrounding area, to be guest-ready candidate tables (guest-ready candidate areas), only in cases where the operating state of the autonomous cleaner 3 is performing cleaning. For example, if the autonomous cleaner 3 is being charged at a charging station (omitted from illustration), or the autonomous cleaner 3 is standing by to receive cleaning instruction information from the management device 2, the autonomous cleaner 3 is not cleaning, and there is no flying dust or noise being made due to cleaning, so the user (employee) can show guests to seating target tables that overlap the surrounding area around the autonomous cleaner 3. According to this configuration, in a case where the operating state of the autonomous cleaner 3 is other than cleaning, seating target tables out of the multiple seating target tables overlapping the surrounding area can be decided to be guest-ready candidate tables.

However, even in this case, it is preferable to not decide on the seating target table where the autonomous cleaner 3 is, as a guest-ready candidate table. Also, in a case where the autonomous cleaner 3 of which the operating state is not cleaning operations is present nearby a table, the autonomous cleaner 3 may obstruct seating of guests. Accordingly, seating target tables nearby the autonomous cleaner 3 of which the operating state is not cleaning operations are preferably not decided to be guest-ready candidate tables. To this end, in a case where the operating state of the autonomous cleaner 3 is not cleaning operations, a predetermined area nearby the autonomous cleaner 3 may be superimposed on the floor plan information. According to this configuration, a situation can be avoided where guests are shown to a table where the autonomous cleaner 3 may obstruct seating.

In this case, the surrounding area information storage unit 154 stores a second surrounding area of the autonomous cleaner 3 that is decided in a case where the operating state is other than cleaning operations, separately from the first surrounding area of the autonomous cleaner 3 decided in a case where the operating state is cleaning operations, with the guest-ready table deciding unit 146 switching between the first surrounding area and second surrounding area in accordance with the operating state of the autonomous cleaner 3. Note that the second surrounding area is an area to avoid the autonomous cleaner 3 from obstructing guests when seating, and accordingly preferably is smaller than the first surrounding area which is an area to avoid flying dust and noise from cleaning.

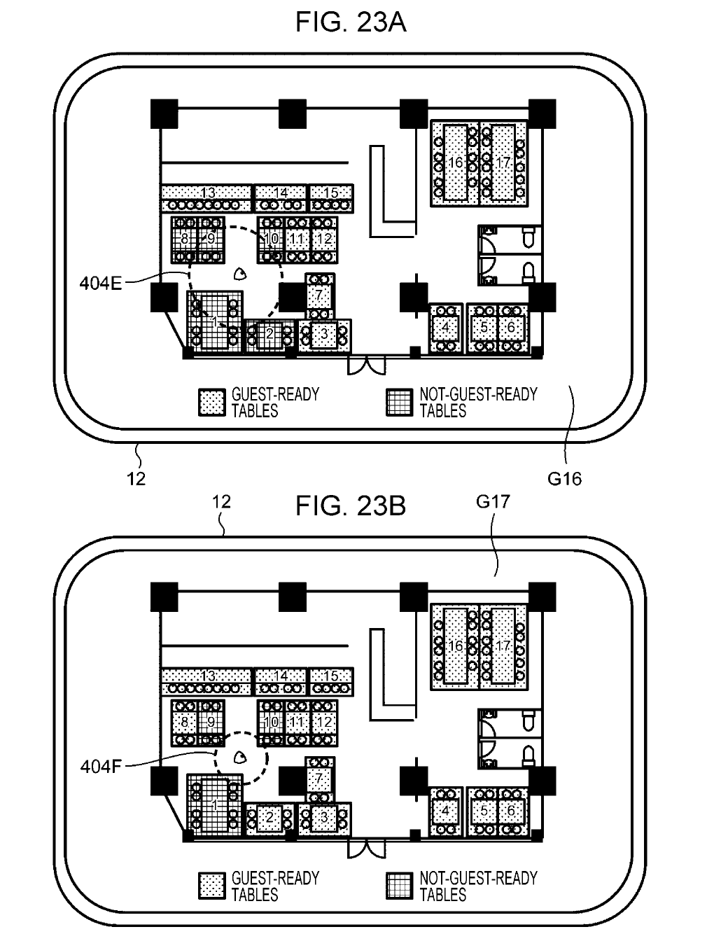

FIGS. 23A and 23B are diagrams for describing processing of switching the size of the surrounding area in accordance with the operating state of the autonomous cleaner in the first embodiment. The display screen G16 illustrated in FIG. 23A is a display screen displayed on the display unit 12 in a case where the operating state of the autonomous cleaner 3 is cleaning operations, and the display screen G17 illustrated in FIG. 23B is a display screen displayed on the display unit 12 in a case where the operating state of the autonomous cleaner 3 is other than cleaning operations.

The guest-ready table deciding unit 146 may decide a first surrounding area 401E indicating a predetermined range from the current position of the autonomous cleaner 3 based on position information, in a case where the operating state of the autonomous cleaner 3 is cleaning operations. The guest-ready table deciding unit 146 may then decide, of the multiple seating target tables (seating target areas), seating target tables (seating target areas) that do not overlap the first surrounding area 404E to be guest-ready candidate tables (guest-ready candidate areas).

In a case where the operating state of the autonomous cleaner 3 is other than cleaning operations, the guest-ready table deciding unit 146 may decide a second surrounding area 401F indicating a predetermined range from the current position of the autonomous cleaner 3 based on position information, that is smaller than the first surrounding area 404E. The guest-ready table deciding unit 146 may then decide, of the multiple seating target tables (seating target areas), seating target tables (seating target areas) that do not overlap the second surrounding area 404F to be guest-ready candidate tables (guest-ready candidate areas). Note that the surrounding area information storage unit 154 may store information relating to the first surrounding area 404E and information relating to the second surrounding area 404F.

Although description has been made above regarding switching the size of the surrounding area based on whether or not the operating state of the autonomous cleaner 3 is cleaning operations, the present disclosure is not restricted to this. In a case where the autonomous cleaner 3 has a function of adjusting the suction force for suctioning dust in accordance with the amount of dust, the size of the surrounding area may be changed in accordance with where the current operating state is a suctioning state of suctioning with a first suction force, and an operating state of operating with a second suction force that is weaker than the first suction force. For example, in a case where the operating state is suctioning with the first suction force, the guest-ready table deciding unit 146 decides on the first surrounding area 404E that indicates a predetermined range from the current position of the autonomous cleaner 3. In a case where the operating state is suctioning with the second suction force that is weaker than the first suction force, the guest-ready table deciding unit 146 decides on the second surrounding area 404F that is smaller than the first surrounding area 404E. The stronger the suction force is, the larger the noise of the autonomous cleaner 3 is, and the more dust may fly, so the stronger the suction force is, the larger the surrounding area preferably is.

Although an arrangement is described in the first embodiment where an input button for prompting display of guest-ready tables is displayed on the display unit 12 of the terminal device 1, and processing to display guest-ready tables is started with detection of the employee 4 pressing the input button as a trigger, the present disclosure is not restricted to this configuration. For example, a camera (omitted from illustration) may be installed at the entrance of the eatery, and the terminal device 1 may start processing to display guest-ready tables in a case of having detected a guest arriving from images taken by the camera. As another configuration, human sensors (omitted from illustration) such as infrared sensors or the like may be installed at the entrance of the eatery, and the terminal device 1 may judge that a guest has arrived when a person is detected at the entrance of the eatery, and start processing to display guest-ready tables.

That is to say, the terminal device 1 may obtain person detection information indicating that a person has entered the predetermined space, and in a case of having obtained person detection information, may update guest-ready areas that are being presented. According to this configuration, guest-ready tables can be displayed without the employee 4 performing input operations to the terminal device 1 so in a case where the employee 4 busy with another task or the like and does not have his/her hands free, guest-ready tables can be automatically displayed. According to this configuration, the displayed guest-ready tables can be automatically updated each time a guest arrives.

In the first embodiment, an input button for prompting display of guest-ready tables is displayed on the display unit 12 of the terminal device 1, and processing to display guest-ready tables is started with detection of the employee 4 pressing the input button as a trigger. Alternatively, the autonomous cleaner 3 may be temporarily stopped when starting processing to display guest-ready tables, with the stopped state of the autonomous cleaner 3 being cancelled after the guests are shown to their table, and processing for displaying guest-ready tables is resumed. The reason is that a case is conceivable where the autonomous cleaner 3 moves while the employee 4 is showing guests to their table after the guest-ready tables have been displayed on the terminal device 1, and a table that was guest-ready at the time of displaying guest-ready tables is not guest-ready by the time the guest is shown to that table.

As an operation to stop the autonomous cleaner 3, for example, the terminal device 1 displays the input button to prompt display of guest-ready tables on the display unit 12, and upon being triggered by detection of the employee pressing the input button, transmits a command to temporarily stop the autonomous cleaner 3 to the autonomous cleaner 3 via the management device 2. The terminal device 1 may directly transmit a command to the autonomous cleaner 3 to stop. In a case where the trigger to start the processing of displaying guest-ready tables is another configuration, such as detecting people entering the eatery or the like, the autonomous cleaner 3 may be stopped in accordance with the other configuration serving as a trigger. Operations of cancelling the stopped state of the autonomous cleaner 3 can be realized by, for example, the employee 4 inputting a stop cancellation instruction to the terminal device 1 after having shown the guests to their table, with the input stop cancellation instruction information being transmitted to the management device 2 and the management device 2 transmitting a command to the autonomous cleaner 3, to cancel the stopped state of the autonomous cleaner 3.

As another method for cancelling the stopped state of the autonomous cleaner 3, pressure sensors (omitted from illustration) may be installed in the seats at the tables, with the management device 2 managing sensing information of the pressure sensors, and at the time of a pressure sensor detecting that a guest has sat down, the management device 2 transmitting a command to cancel the stopped state of the autonomous cleaner 3. Alternatively, instated of pressure sensors, cameras (omitted from illustration) that take images of the tables may be installed, and at the time of a person being present at a seat being detected by the camera images, the management device 2 may transmit a command to cancel the stopped state of the autonomous cleaner 3. Further, infrared sensors (omitted from illustration) may be installed at the seats instated of pressure sensors, and upon a person being detected by the infrared sensors, the management device 2 may transmit a command to cancel the stopped state of the autonomous cleaner 3. As yet another method, the management device 2 may transmit a command to cancel the stopped state of the autonomous cleaner 3 after a predetermined amount of time has elapsed from the time of temporarily stopping the autonomous cleaner 3. In the case of this configuration, the stopped state of the autonomous cleaner 3 cannot be cancelled after showing guests to their table, but cancelling stopped state of the autonomous cleaner 3 can be realized with a simple configuration.

Note that while the terminal device 1 accepts input from the employee 4 to prompt display of guest-ready tables in the first embodiment, the terminal device 1 may further accept input of guest information from the employee 4. Examples of guest information include the number of guests in a group, the makeup of guests, whether non-smoking or smoking is preferred, and so forth. Inputting such information enables the guest-ready table deciding unit 146 to decide guest-ready tables based further on customer information, in addition to unoccupied table information in step S9 in FIG. 9.

The terminal device 1 is described in the first embodiment as being a device that the employee 4 carries, but may be a table information device that is installed unmovably in the eatery to display guest-ready tables to guests, for example.

Once guest-ready tables are displayed, the terminal device 1 thereafter periodically update the guest-ready tables displayed. The autonomous cleaner 3 is constantly moving while cleaning, so while an application displaying guest-ready tables is activated, the terminal device 1 preferably obtains position information of the autonomous cleaner 3 periodically, and updates the surrounding area. That is to say, the communication control unit 142 may periodically obtain position information and unoccupied table information (person-presence information) from the management device (external device) 2 via the communication unit 11, and the display unit 12 may periodically update the guest-ready tables (guest-ready areas) being presented. According to this configuration, the employee 4 can comprehend the position and cleaning state of the autonomous cleaner 3 in real time, and can simulate beforehand which tables guests can be shown to in a case where guests arrive. Thus, when a guest actually does arrive, the employee 4 can immediately decide which table to show the guest to. Note that the time intervals of periodically obtaining position information and unoccupied table information (person-presence information) may be changed partway through, such as being changed from five-minute intervals to three-minute intervals partway through, for example.

In the first embodiment, the guest-ready table deciding unit 146 decides, of the guest-ready candidate tables, guest-ready candidate tables where there is nobody to be guest-ready tables, based on unoccupied table information, but guest-ready tables may be decided further using reservation information. That is to say, based on unoccupied table information and reservation information, the guest-ready table deciding unit 146 may decide, of the guest-ready candidate tables, guest-ready candidate tables where there currently is nobody, and further where there is no reservation for a predetermined amount of time from the current time of day, as being guest-ready tables. According to this configuration, a guest-ready candidate table that currently is unoccupied but is reserved, can be decided to be a not-guest-ready table, and can be kept from being displayed as a guest-ready table.

Now, in a case where the period from the current time of day to the reservation time of day for the guest-ready candidate table that is reserved is long, e.g., in a case where the period from the current time of day to the reservation time of day for the guest-ready candidate table that is reserved exceeds a predetermined period, the guest-ready table deciding unit 146 may decide the guest-ready candidate table that is reserved to be a guest-ready table. On the other hand, in a case where the period from the current time of day to the reservation time of day for the guest-ready candidate table that is reserved is within a predetermined period, the guest-ready table deciding unit 146 may decide the guest-ready candidate table that is reserved to be a not-guest-ready table. According to this configuration, the guest-ready table deciding unit 146 can decide whether or not there are reserved guest-ready candidate tables that can be decided to be guest-ready tables, in accordance with the period from the current time of day to the reserved time of day. Further, even in a case where period from the current time of day to the reservation time of day for the guest-ready candidate table that is reserved exceeds the predetermined period, and the reserved guest-ready candidate table is to be decided to be a guest-ready table, that table needs to be cleared by the reservation time. Accordingly, the guest-ready table deciding unit 146 may decide the reserved guest-ready candidate table to be a conditionally guest-ready table (e.g., usable to so-and-so o'clock), and the display unit 12 may display the conditionally guest-ready table.

Note that the surrounding area information storage unit 154 may store surrounding area information that differs according to each type of autonomous cleaner 3. The structures and functions of autonomous cleaners 3 differ according to the type of autonomous cleaner 3, and when cleaning, the degree of flying dust and noise differs. Accordingly, the surrounding area information storage unit 154 may store multiple sets of surrounding area information in accordance with the types of autonomous cleaners 3, and the guest-ready table deciding unit 146 may decide appropriate surrounding area information in accordance with the type of autonomous cleaner 3.

However, in a case of the terminal device 1 deciding the surrounding area of the autonomous cleaner 3 in this configuration, the surrounding area information appropriate for the type of the autonomous cleaner 3 needs to be selected from the surrounding area information storage unit 154 based on information indicating the type of autonomous cleaner 3. Accordingly, the terminal device 1 needs information indicating the type of autonomous cleaner 3. The information indicating the type of the autonomous cleaner 3 can be obtained from the management device 2. For example, the terminal device 1 transmits request information to the management device 2 for transmission of information relating to the autonomous cleaner 3 that is stored in the cleaner information storage unit 371, and receives the information relating to the autonomous cleaner 3 transmitted from the management device 2 that has received the request information. Information relating to the autonomous cleaner 3 includes information indicating the type of autonomous cleaner 3.

Note that the surrounding area of the autonomous cleaner 3 may be dynamically changed in accordance with the position of the autonomous cleaner 3. For example, in a state where the autonomous cleaner 3 is cleaning inside an enclosed booth in the eatery, the size of the surrounding area preferably is changeable between cases where the autonomous cleaner 3 is inside an enclosed booth and outside an enclosed booth, since the effects of flying dust and noise due to cleaning differ depending on whether inside an enclosed booth and outside an enclosed booth. Accordingly, the guest-ready table deciding unit 146 may change the surrounding area in accordance with the position of the autonomous cleaner 3. An example of a method to change the surrounding area of the autonomous cleaner 3 is for the surrounding area information storage unit 154 to store multiple surrounding areas with different sizes corresponding to the autonomous cleaner 3, and positions of the autonomous cleaner 3 in the eatery (predetermined space), in a correlated manner, and the guest-ready table deciding unit 146 to select the surrounding area correlated with the current position of the autonomous cleaner 3, out of the multiple surrounding areas.

Although the display unit 12 displays guest-ready tables in the first embodiment, the present disclosure is not restricted to this in particular. The terminal device 1 may have an audio output unit (speaker), with the audio output unit outputting audio of guest-ready tables. Also, while one autonomous cleaner 3 is deployed in the predetermined space (eatery) in the first embodiment, multiple autonomous cleaners 3 may be deployed.

### Second Embodiment

A second embodiment will be described. The second embodiment relates to a method performed by the terminal device in processing to display guest-ready tables. In a case where there are no guest-ready tables, a display is made to the effect that there are no guest-ready tables, and an input button capable of stopping the autonomous cleaner is displayed. In a case of detecting that the user has pressed this input button, a stop command is transmitted to stop the autonomous cleaner, guest-ready tables are decided again, and the guest-ready tables that have been decided are displayed.

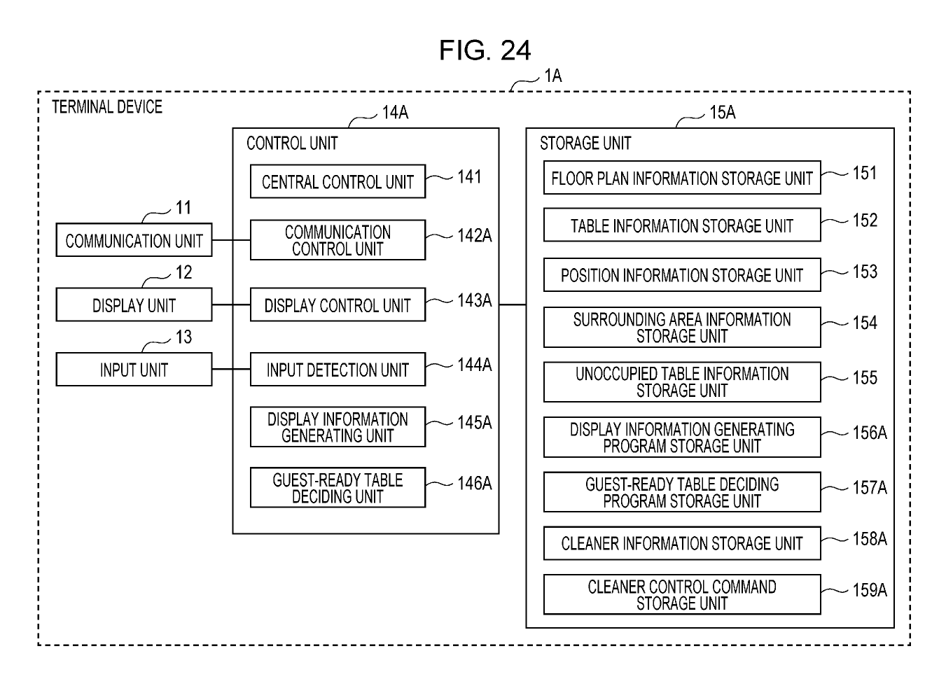

FIG. 24 is a block diagram illustrating the functional configuration of a terminal device in the second embodiment. Components in FIG. 24 that are the same as those of the terminal device 1 illustrated in FIG. 2 are denoted by the same reference symbols, and detailed description will be omitted.

The terminal device 1A illustrated in FIG. 24 differs from the terminal device 1 illustrated in FIG. 2 with regard to a control unit 14A and storage unit 15A. The control unit 14A differs from the control unit 14 of the terminal device 1 illustrated in FIG. 2 with regard to a communication control unit 142A, display control unit 143A, input detection unit 144A, display information generating unit 145A, and guest-ready table deciding unit 146A.

In addition to the processing of the communication control unit 142 illustrated in FIG. 2, the communication control unit 142A further transmits a stop command stored in a cleaner control command storage unit 159A to the management device 2 via the communication unit 11, in a case where the input detection unit 144A detects that the stop button displayed on the display unit 12 for stopping the autonomous cleaner 3 has been pressed by the user.

In addition to the processing of the display control unit 143 illustrated in FIG. 2, in a case where there is no guest-ready table in processing for displaying guest-ready tables, the display control unit 143A further displays display information generated by the display information generating unit 145A to make notification to the effect that there are no guest-ready tables, and a stop button for stopping the autonomous cleaner 3, on the display unit 12.

In addition to the processing of the input detection unit 144 illustrated in FIG. 2, the input detection unit 144A further detects that the stop button displayed on the display unit 12 for stopping the autonomous cleaner 3 has been pressed by the user. The input unit 13 accepts user input of the instruction to stop cleaning by the autonomous cleaner 3. In a case of having accepted user input of an instruction to stop cleaning by the autonomous cleaner 3 at the input unit 13, the communication control unit 142A transmits control information (a stop command) to stop cleaning by the autonomous cleaner 3.

In addition to the processing of the display information generating unit 145 illustrated in FIG. 2, in a case where there is no guest-ready table in processing for displaying guest-ready tables, the display information generating unit 145A further generates display information for making notification to the effect that there are no guest-ready tables, and a stop button for stopping the autonomous cleaner 3. The stop button for stopping the autonomous cleaner 3 is generated so as to be capable of accepting an input operation from the user.

In addition to the processing of the guest-ready table deciding unit 146 illustrated in FIG. 2, in a case of the stop command for stopping the autonomous cleaner 3 being transmitted to the management device 2 via the communication unit 11 by the communication control unit 142A, the guest-ready table deciding unit 146A further performs processing of eliminating the surrounding area of the autonomous cleaner 3 regarding which the stop command was transmitted, and deciding guest-ready tables again. At this time, the guest-ready table deciding unit 146A re-decides multiple seating target tables to be guest-ready candidate tables, without deciding the surrounding area around the autonomous cleaner 3 regarding which cleaning has been stopped.

The storage unit 15A differs from the storage unit 15 of the terminal device 1 illustrated in FIG. 2 with regard to a display information generating program storage unit 156A, guest-ready table deciding program storage unit 157A, cleaner information storage unit 158A, and the cleaner control command storage unit 159A.

In addition to the information that the display information generating program storage unit 156 illustrated in FIG. 2 stores, the display information generating program storage unit 156A further stores a display information generating program that generates, in a case where there are no guest-ready tables, display information for making notification to the effect that there are no guest-ready tables, and a stop button to stop the autonomous cleaner 3.

In addition to the information that the guest-ready table deciding program storage unit 157 illustrated in FIG. 2 stores, the guest-ready table deciding program storage unit 157A further stores a program to, upon a stop command having been transmitted via the communication unit 11, eliminate the surrounding area of the autonomous cleaner 3 regarding which the stop command has been transmitted and decide guest-ready tables again.

The cleaner information storage unit 158A stores information relating to the autonomous cleaner 3. Information relating to the autonomous cleaner 3 includes identification information of the autonomous cleaner 3 to uniquely identify the autonomous cleaner 3, and address information of the autonomous cleaner 3 to establish communication with the autonomous cleaner 3. The information relating to the autonomous cleaner 3 is information necessary for the terminal device 1A to identify which autonomous cleaner 3 to stop, in a case of stopping an autonomous cleaner 3. The information relating to the autonomous cleaner 3 can be obtained from the management device 2 having the cleaner information storage unit 2303 storing information relating to the autonomous cleaner 3, for example. As for another configuration, information relating to the autonomous cleaner 3 may be obtained by accepting settings of information relating to the autonomous cleaner 3 from the user. Alternatively, the address of the terminal device 1A may be set to the autonomous cleaner 3 beforehand, with the autonomous cleaner 3 transmitting information relating to the autonomous cleaner 3 to the terminal device 1A.

The cleaner control command storage unit 159A stores command information for controlling the autonomous cleaner 3. For example, the cleaner control command storage unit 159A stores a stop command for stopping cleaning by the autonomous cleaner 3. The cleaner control command storage unit 159A also stores a command for the autonomous cleaner 3 to perform cleaning, a command for the autonomous cleaner 3 to travel to a predetermined position such as an initial position, and so forth. The command information can be obtained from the management device 2 that has the cleaner control command storage unit 2310 storing command information, for example. Alternatively, command information may be obtained by accepting settings of information relating to the autonomous cleaner 3 from the user.

Description will be made regarding the processing of the terminal device 1A configured as described above displaying guest-ready tables, which is displaying a message for making notification to the effect that there are no guest-ready tables, and a stop button for stopping the autonomous cleaner 3, and further transmitting a stop command for stopping the autonomous cleaner 3 upon having detected pressing of the stop button by the user, deciding guest-ready tables again, and displaying the decided guest-ready tables.

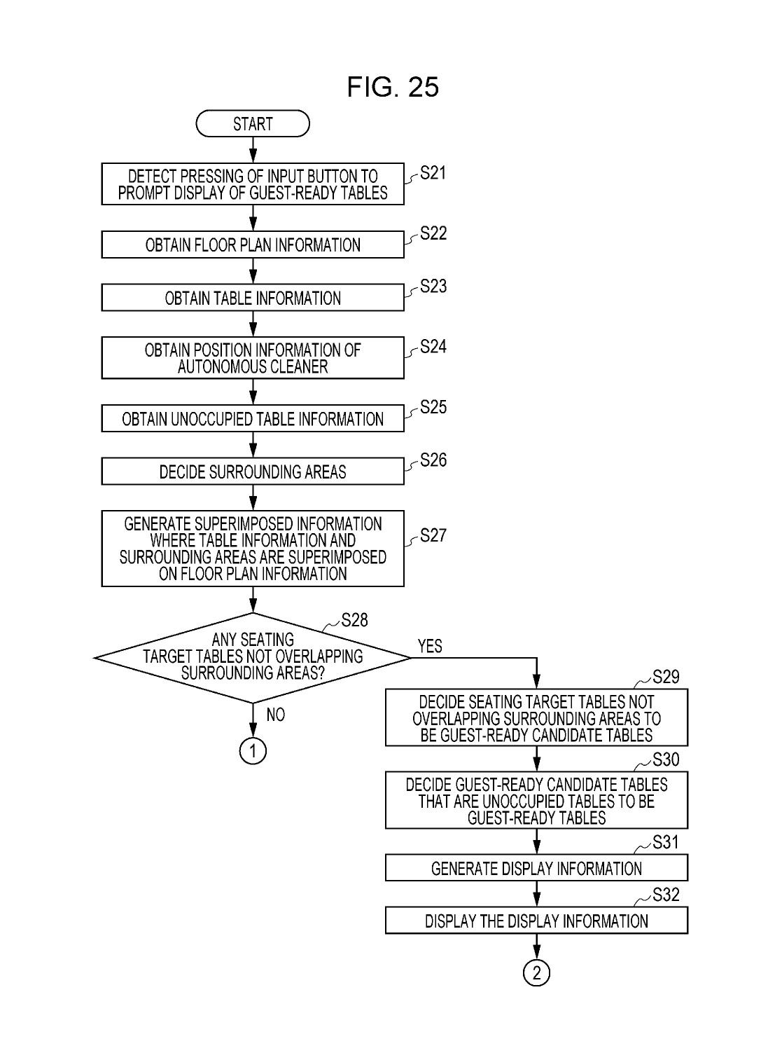

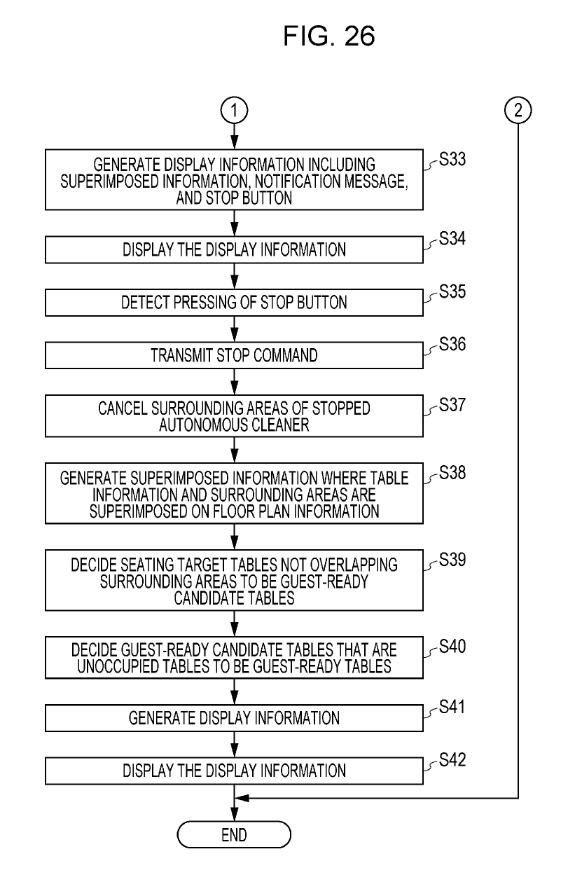

FIG. 25 is a first flowchart for describing processing by the terminal device in the second embodiment, and FIG. 26 is a second flowchart for describing processing by the terminal device in the second embodiment. The processing of steps S21 through S27 and S29 through S32 in FIG. 25 is the same as the processing of steps S1 through S11 in FIG. 9, so detailed description will be omitted. The flowcharts in FIGS. 25 and 26 differ from the flowchart in FIG. 9 with regard to the processing of steps S28 and S33 through S40.

In step S28, the guest-ready table deciding unit 146A judges whether or not, out of all seating target tables, there are seating target tables that do not overlap the surrounding area of the autonomous cleaner 3. In a case where judgment is made that there are seating target tables that do not overlap the surrounding area (YES in step S28), the guest-ready table deciding unit 146A decides, of the multiple seating target tables, the seating target tables that do not overlap the surrounding area of the autonomous cleaner 3 to be guest-ready candidate tables (step S29).

On the other hand, in a case where judgement is made that there are no seating target tables that do not overlap the surrounding area (NO in step S28), the display information generating unit 145A generates display information that includes superimposed information where the position of the autonomous cleaner 3, the multiple seating target tables, and the surrounding area, have been superimposed on the floor plan information, and also generates a notification message to make notification to the effect that there are no guest-ready tables, and a stop button for stopping the autonomous cleaner 3, based on the display information generating program storage unit 156A (step S33).

Next, the display control unit 143A displays the generated display information on the display unit 12 (step S34).

The display control unit 143A displays the display information which includes the superimposed information where the position of the autonomous cleaner 3, the multiple seating target tables, and the surrounding area, have been superimposed on the floor plan information, the notification message to make notification to the effect that there are no guest-ready tables, and the stop button for stopping the autonomous cleaner 3, that have been generated by the display information generating unit 145A, on the display unit 12 (step S34).

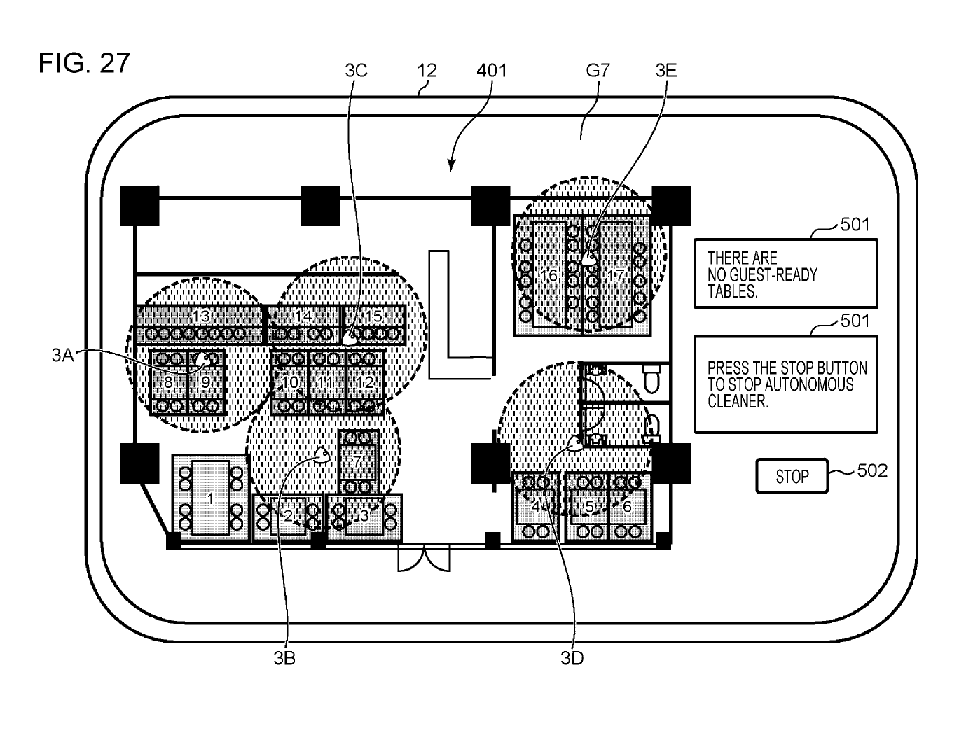

FIG. 27 is a diagram illustrating an example of a display screen displaying superimposed information, a notification message making notification to the effect that there are no guest-ready tables, and a stop button for stopping the autonomous cleaner, in the second embodiment.

A display screen G7 illustrated in FIG. 27 includes the superimposed information 401 where the position of autonomous cleaners 3, table information, and surrounding area have been superimposed on the floor plan information, a notification message 501 to make notification to the effect that there are no guest-ready tables, and a stop button 502 for stopping the autonomous cleaners 3. Multiple autonomous cleaners 3A through 3E are cleaning in the eatery in FIG. 27, and a state is represented where all seating target tables are overlapping the surrounding area of one of the multiple autonomous cleaners 3A through 3E, so accordingly there are not guest-ready tables. The notification message 501 makes a display “THERE ARE NO GUEST-READY TABLES. PRESS THE STOP BUTTON TO STOP AUTONOMOUS CLEANER.”

Next, the input detection unit 144A detects that the user has pressed the stop button displayed on the display unit 12 for stopping the autonomous cleaners 3 (step S35).

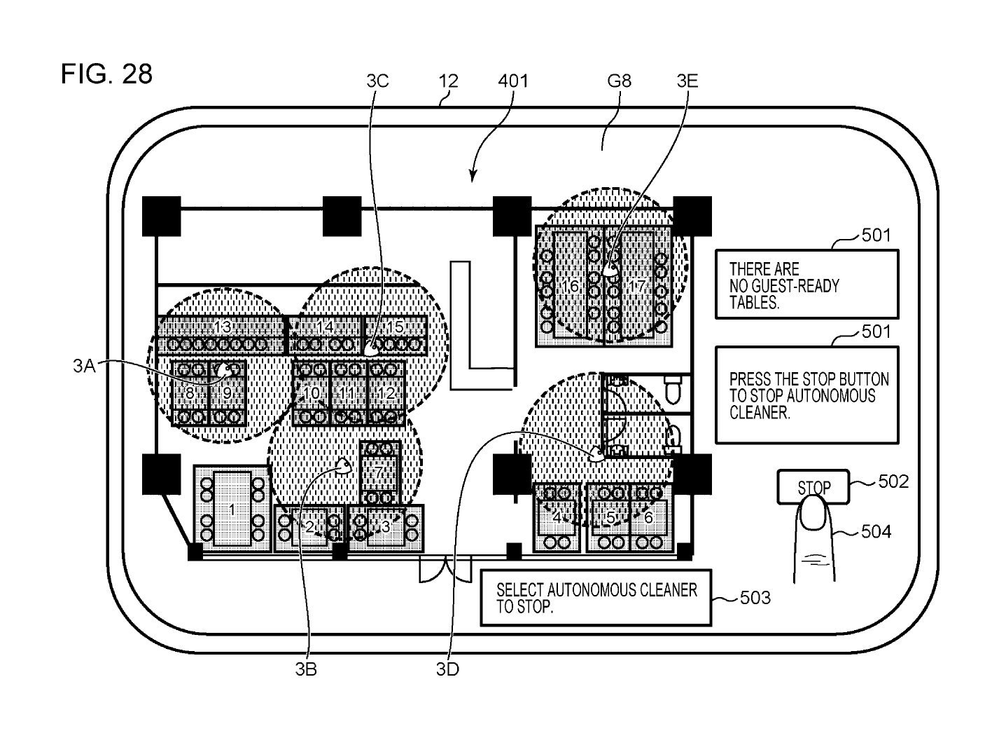

In a case where multiple autonomous cleaners 3 are present at this time, the input unit 13 may accept selection of which autonomous cleaner 3 out of the multiple autonomous cleaners 3 is to be stopped. For example, in a case where the user presses the stop button to stop the autonomous cleaner 3, the display control unit 143A displays a message prompting the user to select which autonomous cleaner 3 of the multiple autonomous cleaners 3 to stop. The display control unit 143A then causes the user to select which autonomous cleaner 3 of the multiple autonomous cleaners 3 to stop. The series of processing for selecting the autonomous cleaner 3 to stop will be described with reference to FIGS. 28 through 30.

FIG. 28 is a diagram illustrating an example of a display screen displaying a selection accepting message prompting selection of an autonomous cleaner 3 to be stopped in the second embodiment. Upon the stop button 502 for stopping the autonomous cleaner 3 being pressed by a finger 504 of the user, for example, in a display screen G8 illustrated in FIG. 28, a selection accepting message 503 that prompts selection of which autonomous cleaner 3 of the multiple autonomous cleaners 3A through 3E to stop is displayed. Once the selection accepting message 503 is displayed, the display control unit 143A then selectably displays icons representing the multiple autonomous cleaners 3A through 3E in the display screen G8.

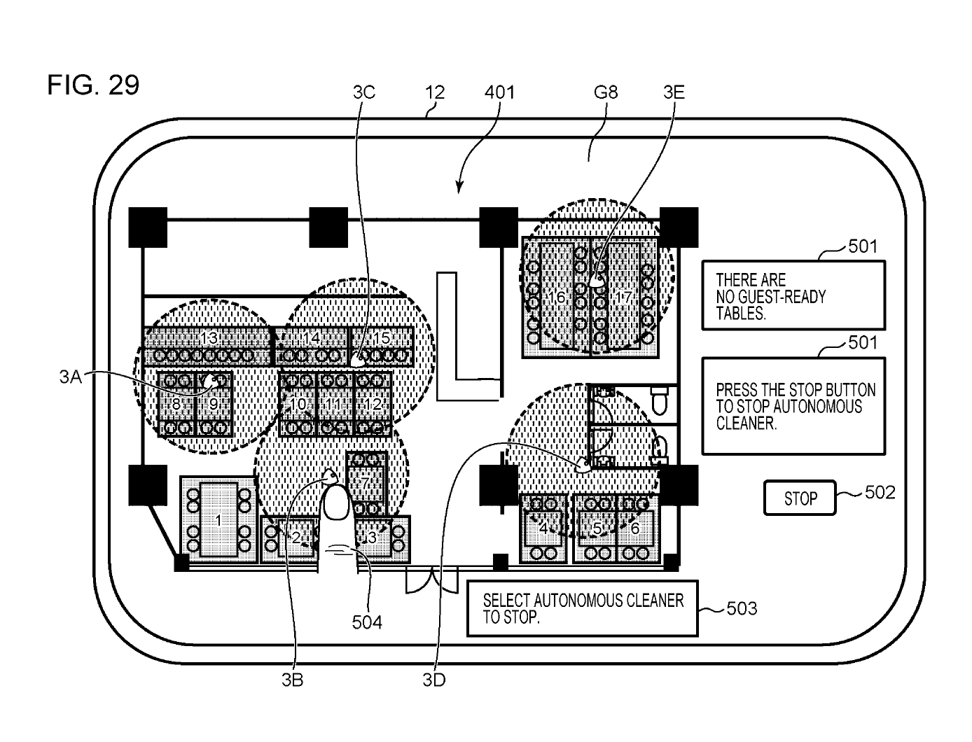

FIG. 29 is a diagram illustrating an example of a display screen accepting selection of one autonomous cleaner out of multiple autonomous cleaners 3 in the second embodiment. In the display screen G8 illustrated in FIG. 29, the user selects the icon for the autonomous cleaner 3 to be stopped, out of icons from the multiple autonomous cleaners 3A through 3E. In the example illustrated in FIG. 29, the icons of the multiple autonomous cleaners 3A through 3E are correlated to information of the multiple autonomous cleaners 3A through 3E stored in the cleaner information storage unit 158A, and further is displayed so as to be able to accept user input. According to this configuration, when the user presses the icon of any one of the multiple autonomous cleaners 3A through 3E by the finger 504, the user can reference the information stored in the cleaner information storage unit 158A correlated with the icons. Note that the method of selecting the autonomous cleaner 3 to stop is not restricted to a configuration of selecting an icon of an autonomous cleaner 3. For example, an arrangement may be made where the display control unit 143A displays a list of the multiple autonomous cleaners 3A through 3E, and accepts user selection of the autonomous cleaner 3 to stop from the list. Note that in FIG. 29, the icon of the autonomous cleaner 3B is pressed to stop the autonomous cleaner 3B.

Returning to FIG. 26, the input detection unit 144A detects that the stop button for stopping the autonomous cleaner 3 has been pressed (step S35). The communication control unit 142 A identifies the autonomous cleaner 3 to stop, based on information detected by the input detection unit 144A. For example, in the example illustrated in FIG. 29, the input detection unit 144A detects that the icon of the autonomous cleaner 3B has been pressed. The communication control unit 142A identifies the autonomous cleaner 3B to be stopped, from information relating to the autonomous cleaner 3B that is stored in the cleaner information storage unit 158A, correlated to the autonomous cleaner 3B detected by the input detection unit 144A. In a case where there is no detection of the stop button having been pressed, the processing of the terminal device 1A may be stopped after a predetermined amount of time has elapsed.

Next, the communication control unit 142A extracts, from the cleaner control command storage unit 159A, a stop command to stop the autonomous cleaner 3 identified in step S35, and transmits the extracted stop command to the management device 2 (step S36).

Next, upon the communication control unit 142A transmitting the command to stop the autonomous cleaner 3 to the management device 2, the guest-ready table deciding unit 146A cancels the surrounding area of the autonomous cleaner 3 that has been stopped, out of the surrounding areas of the autonomous cleaners 3 superimposed on the floor plan information in step S6 (step S37).

In steps S38 through S42, the guest-ready table deciding unit 146A performs processing to decide guest-ready tables again, and displays the guest-ready tables. Note that the processing in steps S38 through S42 is the same as the processing in steps S7 through S11 in FIG. 9, so description will be omitted.

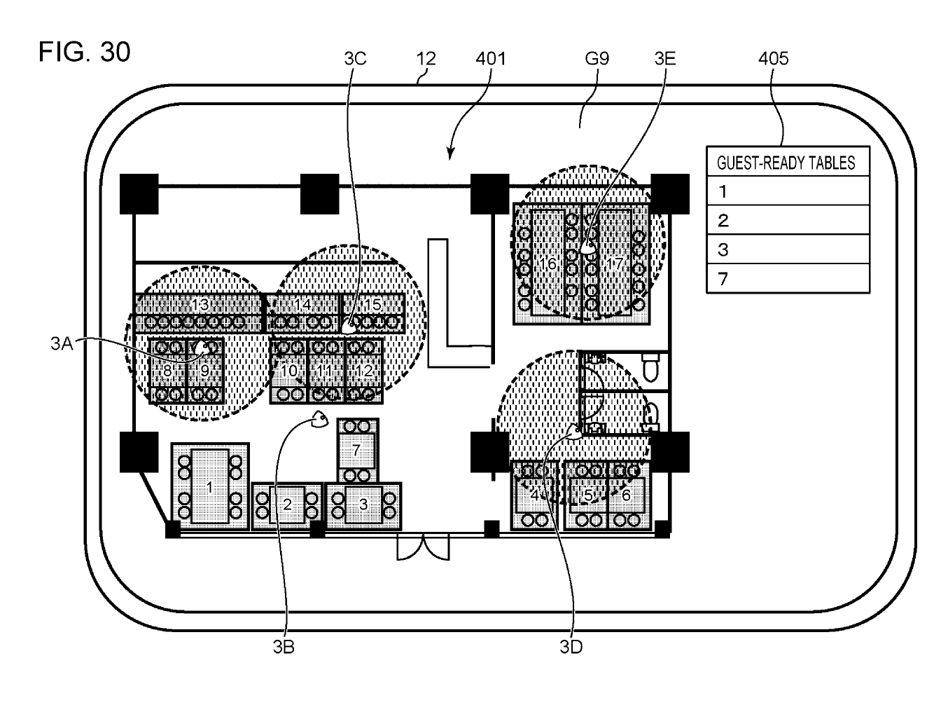

FIG. 30 is a diagram illustrating an example of a display screen displaying guest-ready tables after an autonomous cleaner 3 has been stopped in the second embodiment. A display screen G9 illustrated in FIG. 30 is an example of a display screen displayed after the user has selected the autonomous cleaner 3B in the display screen G8 illustrated in FIG. 29, and the communication control unit 142A has transmitted a stop command to stop the autonomous cleaner 3B to the management device 2.

Comparing the display screen G9 illustrated in FIG. 30 with the display screen G8 illustrated in FIG. 29, the surrounding area of the autonomous cleaner 3B has been eliminated. Accordingly, the guest-ready table deciding unit 146A can decide the seating target tables not overlapping the surrounding areas, out of the multiple seating target tables, as guest-ready candidate tables. In the example illustrated in FIG. 30, the seating target tables corresponding to the table identification Nos. “1” through “3” and “7” do not overlap any surrounding area, due to having stopped the autonomous cleaner 3B, so the seating target tables corresponding to the table identification Nos. “1” through “3” and “7” are decided to be guest-ready candidate tables. The guest-ready table deciding unit 146A then decides, of the decided guest-ready candidate tables, guest-ready candidate tables that are unoccupied tables to be guest-ready tables. In the example illustrated in FIG. 30, guest-ready candidate tables corresponding to the table identification Nos. “1” through “3” and “7” are newly decided to be guest-ready tables.

The display screen G9 illustrated in FIG. 30 includes the guest-ready table list 405 where guest-ready tables have been compiled into a list. The guest-ready table list 405 includes table identification Nos. indicating the guest-ready tables.

According to the processing described above, even in a case where there are no guest-ready tables in processing for displaying guest-ready tables, guest-ready tables can be newly decided by stopping the autonomous cleaner 3 and deciding guest-ready candidate tables again, and further the guest-ready tables can be displayed. Accordingly, even in a case where there are no guest-ready tables, the guest-ready tables can be adjusted by judgement made by the user regarding whether to stop cleaning by the autonomous cleaner 3.

Note that in the second embodiment, after the communication control unit 142A of the terminal device 1A has transmitted a stop command to the management device 2 to stop the autonomous cleaner 3 in step S36 in FIG. 26, the guest-ready table deciding unit 146A cancels the surrounding area of the stopped autonomous cleaner 3 in step S37. However, it is preferable that the communication control unit 142A of the terminal device 1A transmits a stop command to the management device 2 to stop the autonomous cleaner 3 in step S36 in FIG. 26, and the guest-ready table deciding unit 146A performs the processing in step S37 after having received a message from the management device 2 to the effect that the autonomous cleaner 3 has stopped. The reason is as follows. The terminal device 1A transmitting a stop command to the management device 2 to stop the autonomous cleaner 3 does not in itself actually stop the autonomous cleaner 3. In a case where the stop command is not transmitted from the management device 2 to the autonomous cleaner 3 for some reason, the autonomous cleaner 3 will continue operating, and as a result, there will be a discrepancy between the actual state of the autonomous cleaner 3 and the display of guest-ready tables.

Note that while the surrounding area of the stopped autonomous cleaner 3 is eliminated in the second embodiment, a surrounding area may be set in accordance with the stopped autonomous cleaner 3. In a case where the autonomous cleaner 3 is stopped, the autonomous cleaner 3 may inconvenience guests at the position where the autonomous cleaner 3 has stopped and at tables near the position where the autonomous cleaner 3 has stopped. Accordingly, guests are preferably not shown to tables near the autonomous cleaner 3. For example, in a case where a guest moves a chair to sit down at a table near the stopped autonomous cleaner 3, the chair may strike the stopped autonomous cleaner 3. Accordingly, setting guest-ready candidate tables other than those in the proximity of the stopped autonomous cleaner 3 as guest-ready tables helps to avoid guests from being shown to tables where there is a higher chance of the stopped autonomous cleaner 3 inconveniencing guests in being seated.

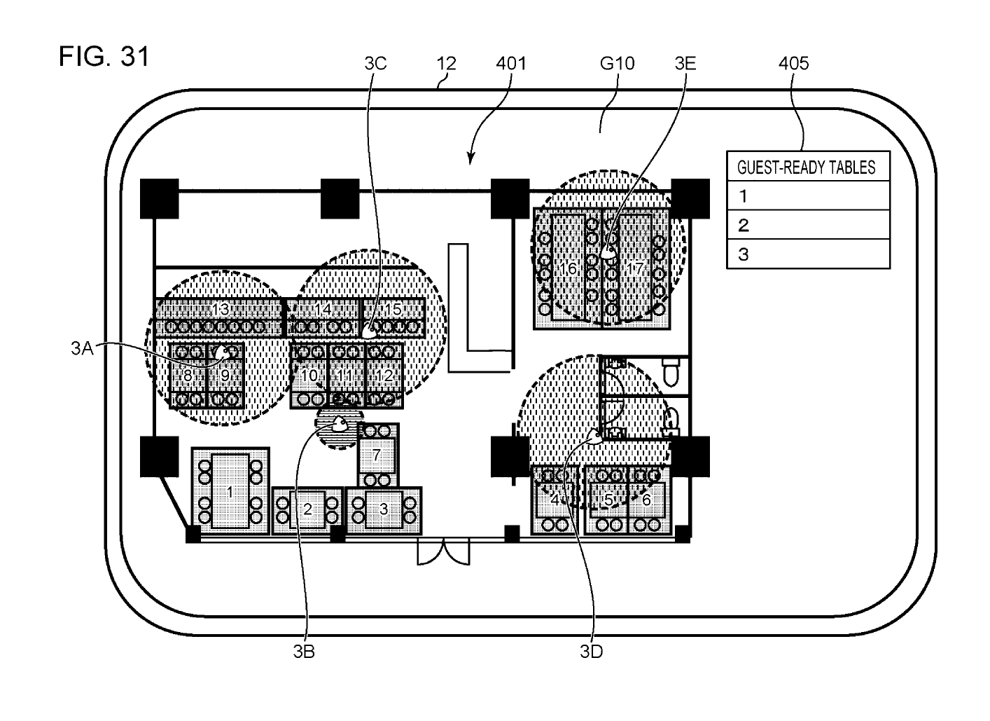

FIG. 31 is a diagram illustrating an example of a display screen displaying guest-ready tables decided in a case where the size of the surrounding area of an autonomous cleaner 3 that has been stopped is reduced in the second embodiment. The difference between FIGS. 31 and 30 is that while the surrounding area of the autonomous cleaner 3B has been eliminated in FIG. 30, the surrounding area of the autonomous cleaner 3B is reduced in FIG. 31. A display screen G10 illustrated in FIG. 31 is an example of a display screen displayed after the user has selected the autonomous cleaner 3B in the display screen G8 illustrated in FIG. 29, the communication control unit 142A has transmitted the stop command for stopping the autonomous cleaner 3B to the management device 2, and the guest-ready table deciding unit 146A has reduced the surrounding area of the autonomous cleaner 3B.

The surrounding area of the autonomous cleaner 3B is reduced in the display screen G10 illustrated in FIG. 31 as compared with the display screen G8 illustrated in FIG. 29. Accordingly, the guest-ready table deciding unit 146A decides, of the multiple seating target tables, seating target tables not overlapping the surrounding area to be guest-ready candidate tables. In the example illustrated in FIG. 31, seating target tables corresponding to table identification Nos. “1” through “3” do not overlap the surrounding area due to the autonomous cleaner 3B having been stopped, so the seating target tables corresponding to table identification Nos. “1” through “3” are decided to be guest-ready candidate tables. Of the decided guest-ready candidate tables, the guest-ready table deciding unit 146A decides guest-ready candidate tables that are unoccupied tables to be guest-ready tables. In the example illustrated in FIG. 31, guest-ready candidate tables corresponding to table identification Nos. “1” through “3” are newly decided to be guest-ready tables.

The display screen G10 illustrated in FIG. 31 includes the guest-ready table list 405 where the guest-ready tables have been complied into a list. The guest-ready table list 405 includes table identification Nos. indicating guest-ready tables.

Although description has been made regarding the second embodiment that, in a case where there are no guest-ready tables in the processing of displaying guest-ready tables, a stop button to stop the autonomous cleaner 3 is displayed along with a notification message making notification to the effect that there are no guest-ready tables, but even in a case where there are guest-ready tables, the stop button to stop the autonomous cleaner 3 may be displayed along with the guest-ready tables. According to this configuration, in a case where the employee shows a guest to a guest-ready table displayed on the terminal device 1A, but the guest does not care for that table and rather prefers a not-guest-ready table overlapping the surrounding area of the autonomous cleaner 3, the autonomous cleaner 3 can be stopped and the guest can be shown to the desired table.

Although the surrounding area of the autonomous cleaner 3 is eliminated by stopping the autonomous cleaner 3 while cleaning to find new guest-ready tables in the second embodiment, an arrangement may be made where new guest-ready tables are decided by moving the autonomous cleaner 3 to a predetermined position, such as an initial position or the like, for example. According to this configuration, the task of the user recovering the stopped autonomous cleaner 3 becomes unnecessary.

Although the terminal device 1A transmits cleaner control commands to the management device 2 and the management device 2 transmits the received cleaner control commands to the autonomous cleaner 3 in the second embodiment, the terminal device 1A may transmit request information for stopping the autonomous cleaner 3 to the management device 2 instated of cleaner control commands, and the management device 2 may transmit cleaner control commands to the autonomous cleaner 3 in accordance with the received request information. This configuration yields the same advantages as those of the above-described second embodiment.

Although the terminal device 1A transmits a stop command to stop the autonomous cleaner 3 to the management device 2 in step S36 in the second embodiment, other commands may be transmitted as commands to stop flying dust and noise due to the cleaning by the autonomous cleaner 3. For example, the terminal device 1A may transmit a command to stop cleaning operations, or a command to place the autonomous cleaner 3 in a standby mode, where the autonomous cleaner 3 is temporarily stopped and is standing by at that location.

Although multiple autonomous cleaners 3A through 3E are deployed in the predetermined space in the second embodiment, just one autonomous cleaner 3 may be deployed.

Although a cleaning support method for an autonomous cleaner according to one or multiple forms of the present disclosure has been described by way of an embodiment, the present disclosure is not restricted to this embodiment. Various modifications that will be conceivable by one skilled in the art, and forms constructed by combining components of different embodiments, without departing from the essence of the present disclosure, may also be encompassed by the scope of one or multiple forms of the present disclosure.

In the first and second embodiments, the management device 2 may have part of the functions of the control unit and storage unit of the terminal devices 1 and 1A. Alternatively, the terminal devices 1 and 1A may have part of the functions of the control unit and storage unit of the management device 2. Further, a single device may have the functions of both the terminal devices 1 and 1A and the management device 2.

In the above-described embodiments, the components may be configured as dedicated hardware, or may be realized by executing software programs suitable for the components. The components may be realized by a program executing unit such as a CPU or other processor reading out and executing software programs recorded in a recording medium such as a hard disk or semiconductor memory or the like.

All or part of the functions of the terminal device according to the first and second embodiments may be realized by large scale integration (LSI) that is typically an integrated circuit. These may be individually formed on signal chips, or part or all may be included on a single chip. Circuit integration is not restricted to LSI, and maybe realized by dedicated circuits or general-purpose processors. Field-programmable gate arrays (FPGA) that can be programmed after manufacturing of the LSI, and reconfigurable processors where connections and settings of circuit cells within the LSI can be reconfigured may also be used.

Also, part or all of the functions of the terminal device according to the first and second embodiments may be realized by a processor such as a CPU executing a program.

Note that the numerals used in the above description are all only exemplary to describe the present disclosure in detail, and that the present disclosure is not restricted to the numerals that have been exemplified.

The order in which the steps in FIGS. 9, 25, and 26 are executed as described above is only exemplary to describe the present disclosure in detail, and that orders other than that described above may be used, as long as the same advantages can be obtained. Also, part of the above steps may be executed at the same time (in parallel) with other steps.

Further, various modifications where embodiments of the present disclosure are modified within a scope conceivable by one skilled in the art, without departing from the essence of the present disclosure, are also included in the present disclosure.

The presenting method, presenting device, and non-transitory computer-readable recording medium storing a presenting program, according to the present disclosure, by which, when an autonomous cleaner is cleaning within a predetermined space, a person can be shown to a predetermined area within the predetermined space, taking into consideration the position where the autonomous cleaner is cleaning, and can be shown to an area where the effects of flying dust and noise due to the autonomous cleaner performing cleaning is small, and are useful as a presenting method, presenting device, and non-transitory computer-readable recording medium storing a presenting program presenting a destination to show a person to in the predetermined space that the autonomous cleaner is cleaning.

What is claimed is:

1. A presenting method for a terminal device having a processor, a display, and a memory, the method comprising:
obtaining, by the processor, an electronic floor plan of a predetermined space, the predetermined space being a cleaning range of the autonomous cleaner;
obtaining, by the processor, area information indicating a plurality of seating target areas, the plurality of seating target areas being obtained by dividing the floor plan of the predetermined space;
obtaining, by the processor, position information indicating a current position of the autonomous cleaner in the predetermined space;
obtaining, by the processor, person-presence information indicating whether or not a person is present in one of the plurality of seating target areas;
identifying, by the processor, a first surrounding area of the autonomous cleaner based on the current position of the autonomous cleaner, the first surrounding area indicating a predetermined range around the autonomous cleaner;
determining, by the processor, among the plurality of seating target areas, seating target areas not overlapping with the first surrounding area as being guest-ready candidate areas;
determining, by the processor, among the guest-ready candidate areas, guest-ready candidate areas where there is no person present as being guest-ready areas; and
displaying, on the display, the determined guest-ready areas.

2. The presenting method according to claim 1, further comprising:
determining, by the processor, among the plurality of seating target areas, seating target areas other than the guest-ready areas as being not-guest-ready areas; and
displaying, on the display, the guest-ready areas and not-guest-ready areas using different forms.

3. The presenting method according to claim 2, further comprising:
determining, by the processor, among the not-guest-ready areas, seating target areas where a person is present based on the person-presence information, as being first not-guest-ready areas;
determining, by the processor, among the not-guest-ready areas, not-guest-ready areas overlapping the first surrounding area as being second not-guest-ready areas; and
displaying, on the display, the first not-guest-ready areas and the second not-guest-ready areas using different forms.

4. The presenting method according to claim 1, further comprising:
obtaining, by the processor, degree-of-priority imparting condition information indicating a condition for imparting a degree of priority to a guest-ready area;
imparting, by the processor, a degree of priority to each of the plurality of guest-ready areas, based on the degree-of-priority imparting condition information; and
displaying, on the display, the plurality of guest-ready areas using different forms based on the degree of priority.

5. The presenting method according to claim 4, wherein the degree-of-priority imparting condition information includes a condition of imparting a first degree of priority in order from a guest-ready area that is farthest away from the current position of the autonomous cleaner.

6. The presenting method according to claim 4, wherein the degree-of-priority imparting condition information includes a condition of imparting a first degree of priority in order from a guest-ready area being associated with a most recent cleaning completion time by the autonomous cleaner.

7. The presenting method according to claim 4, wherein the plurality of guest-ready areas are displayed in a descending order priority.

8. The presenting method according to claim 1, further comprising:
obtaining, by the processor, state information indicating an operating state of the autonomous cleaner; and
determining, by the processor and only when the operating state of the autonomous cleaner indicates performance of cleaning operations, among the plurality of seating target areas, seating target areas that do not overlap the first surrounding area as being the guest-ready candidate areas.

9. The presenting method according to claim 8, further comprising:
determining, by the processor, when the operating state of the autonomous cleaner indicates a state other than the performance of cleaning operations, a second surrounding area that represents a predetermined range from the current position of the autonomous cleaner based on the position information, the second surrounding area being smaller than the first surrounding area; and
determining, by the processor, among the plurality of seating target areas, seating target areas not overlapping the second surrounding area as being guest-ready candidate areas.

10. The presenting method according to claim 1, further comprising:
periodically updating the position information and the person-presence information based on updated information received from an external device; and
periodically updating the presented guest-ready areas based on the updated position information and the updated person present information.

11. The presenting method according to claim 1, further comprising:
obtaining, by the processor, person detection information indicating that a person has entered the predetermined space; and
updating the presented guest-ready areas when the person detection information is obtained.

12. The presenting method according to claim 1, further comprising:
transmitting, by a transmitter, control information to stop the cleaning operations by the autonomous cleaner when an input from a user instructing stopping of the cleaning operations by the autonomous cleaner is received; and
re-determining, by the processor, the plurality of seating target areas as being the guest-ready candidate areas, without deciding the first surrounding area around the autonomous cleaner that has been instructed to stop the cleaning operations.

13. A presenting device comprising:
processing circuitry; and
a memory storage including at least one set of instructions that, when executed by the processing circuitry, cause the processing circuitry to perform operations including
obtaining an electronic floor plan of a predetermined space, the predetermined space being a cleaning range of the autonomous cleaner;
obtaining area information indicating a plurality of seating target areas, the plurality of seating target areas being obtained by dividing the floor plan of the predetermined space,
obtaining position information indicating a current position of the autonomous cleaner in the predetermined space,
obtaining person-presence information indicating whether or not a person is present in one of the plurality of seating target areas,
identifying a first surrounding area of the autonomous cleaner based on the current position of the autonomous cleaner, the first surrounding area indicating a predetermined range around the autonomous cleaner,
determining, among the plurality of seating target areas, seating target areas not overlapping with the first surrounding area as being guest-ready candidate areas,
determining, among the guest-ready candidate areas, guest-ready candidate areas where there is no person present as being guest-ready areas, and
displaying the determined guest-ready areas.

14. A non-transitory computer-readable recording medium storing a program, that when executed by a computer, causes the computer to execute a method including
obtaining an electronic floor plan of a predetermined space, the predetermined space being a cleaning range of the autonomous cleaner;
obtaining area information indicating a plurality of seating target areas, the plurality of seating target areas being obtained by dividing the floor plan of the predetermined space,
obtaining position information indicating a current position of the autonomous cleaner in the predetermined space,
obtaining person-presence information indicating whether or not a person is present in one of the plurality of seating target areas,
identifying a first surrounding area of the autonomous cleaner based on the current position of the autonomous cleaner, the first surrounding area indicating a predetermined range around the autonomous cleaner,
determining, among the plurality of seating target areas, seating target areas not overlapping with the first surrounding area as being guest-ready candidate areas,
determining, among the guest-ready candidate areas, guest-ready candidate areas where there is no person present as being guest-ready areas, and
displaying the determined guest-ready areas.
